(19) United States
(12) Patent Application Publication
(10) Pub. No.: US 2014/0331180 A1
(43) Pub. Date: Nov. 6, 2014

(54) GRAPHICAL USER INTERFACE THAT PRESENTS SELECTABLE ITEMS IN A USER-TRAVERSABLE PASSAGEWAY

(71) Applicant: Fei Ju, Markham (CA)

(72) Inventor: Fei Ju, Markham (CA)

(21) Appl. No.: 14/299,682

(22) Filed: Jun. 9, 2014

Related U.S. Application Data
(63) Continuation-in-part of application No. PCT/CA2013/050338, filed on May 1, 2013.

(30) Foreign Application Priority Data
Apr. 30, 2014 (CA) 2850738

(51) Int. Cl. G06F 3/0482; G06F 3/0484; G06F 3/0481

(52) U.S. Cl. CPC G06F 3/0482; G06F 3/04817; G06F 3/04815; G06F 3/04842; G06F 3/04845
USPC 715/815

(57) ABSTRACT

A graphical user interface (GUI) is provided that presents selectable items for selection by a user. The GUI presents wall panels forming a graphical representation of a passageway appearing to extend away from the user. Each wall panel has a panel size commensurate with the apparent distance of that wall panel to the user. Each selectable item is associated with one of the wall panels displaying thereon an image representative of that selectable item. In response to receiving a user request for movement along the passageway, the graphical representation of the passageway is updated to reflect the movement, such that sizes of visible wall panels are adjusted to be commensurate with their respective current apparent distances to the user, thereby allowing the user to traverse the passageway to view and select the image displayed on each one of the wall panels associated with the selectable items.

### CROSS-REFERENCE TO RELATED APPLICATIONS

This application is a continuation-in-part of PCT international application no. PCT/CA2013/050338 filed May 1, 2013, the entire contents of which are hereby incorporated herein by reference.

This application claims the benefits and priority from Canadian patent application no. 2,850,738, filed Apr. 30, 2014, the entire contents of which are hereby incorporated herein by reference.

### TECHNICAL FIELD

This relates to graphical user interfaces (GUIs) for electronic devices, and more particularly, to GUIs that present selectable items in a user-traversable passageway.

### BACKGROUND

Conventional GUIs may be configured to present selectable items for selection by a user. For example, a GUI for a computer may present a plurality of files or applications for selection by a user. However, when required to present a large number of selectable items, conventional GUIs typically divide up those items and present them on multiple pages or multiple screens. This requires a user to first select a particular page or a particular screen before selecting an item, which may reduce selection efficiency.

### SUMMARY

In an aspect, there is provided a method of presenting selectable items on an electronic display for selection by a user. The method includes presenting on the display a plurality of wall panels forming a graphical representation of a passageway appearing to extend away from the user, each one of the wall panels having a panel size commensurate with the apparent distance of that wall panel to the user, each one of the selectable items being associated with one of the wall panels displaying thereon an image representative of that selectable item; and in response to receiving from the user a request for movement along the passageway, updating the graphical representation of the passageway to reflect the movement, such that sizes of visible wall panels in the passageway are adjusted to be commensurate with their respective current apparent distances to the user, thereby allowing the user to traverse the passageway to view and select the image displayed on each one of the wall panels associated with the selectable items.

The method may also include receiving from the user a request to select the image displayed on a particular one of the wall panels, and in response to the request to select, selecting the particular wall panel as an active panel.

The method may also include activating the particular selectable item associated with the active panel. The activating may be in response to receiving from the user a further request to activate the particular selectable item.

The method may also include updating the graphical representation of the passageway to highlight the active panel.

The method may also include rotating the active panel to face the user.

The selectable items may be selected from image files, audio files, movie files, executable applications, electronic documents, and web pages.

The selectable items may include executable applications, and the method may also include in response to receiving a request from the user to activate a selected one of the executable applications, executing the selected executable application. Each of the wall panels may be associated with one of the executable applications displaying an icon of that executable application.

The selectable items may include image files, and the method may also include in response to receiving a request from the user to activate a selected one of the image files, displaying the selected image file.

The selectable items may include electronic documents, and the method may also include in response to receiving a request from the user to activate a selected one of the electronic documents, executing an application to open the selected electronic document.

The method may also include automatically identifying the selectable items by scanning a filesystem for items meeting pre-defined criteria.

The passageway may be three-dimensional, and the graphical representation may represent a two-dimensional projection of the three-dimensional passageway. The wall panels may include trapezoidal panels that represent two-dimensional projections of rectangular wall panels in the passageway.

In another aspect, there is provided a computing device comprising an electronic display; a processor; an input; and memory storing processor-executable code. The code, when executed by the processor, causes the device to: present on the display a plurality of wall panels forming a graphical representation of a passageway appearing to extend away from a user of the device, each one of the wall panels having a panel size commensurate with the apparent distance of that wall panel to the user, each one of a plurality of selectable items being associated with one of the wall panels displaying thereon an image representative of that selectable item; and in response to receiving from the user, through the input, a request for movement along the passageway, updating the graphical representation of the passageway to reflect the movement, such that sizes of visible wall panels in the passageway are adjusted to be commensurate with their respective current apparent distances to the user, thereby allowing the user to traverse the passageway to view and select the image displayed on each one of the wall panels associated with the selectable items.

The selectable items may be stored in the memory.

The device may be a desktop computing device, a laptop computing device, a smart phone, a tablet computer, an e-book reader, a set-top-box, a digital video recorder, a gaming console, or a digital television.

The display may be a touchscreen display.

The passageway may be three-dimensional and the graphical representation may represent a two-dimensional projection of the three-dimensional passageway.

The wall panels may include trapezoidal panels that represent two-dimensional projections of rectangular wall panels in the passageway.

Other features will become apparent from the drawings in conjunction with the following description.

### BRIEF DESCRIPTION OF THE DRAWINGS

In the figures which illustrate example embodiments,

FIG. 1 is a front perspective view of a computing device for presenting a GUI, exemplary of an embodiment.

FIG. 2 a high-level block diagram of the computing device of FIG. 1;

FIG. 3 is a high-level block diagram illustrating the software organization of the computing device of FIG. 1;

FIG. 4 is a high-level block diagram of the modules of the GUI software of FIG. 3;

FIG. 5 is an exemplary screen showing a graphical representation of a passageway presented by the GUI software of FIG. 3;

FIG. 6 is an exemplary screen showing a graphical representation of the passageway of FIG. 5, with wall panels displaying thumbnails of selectable image files;

FIG. 7 is an exemplary screen showing a graphical representation of another passageway presented by the GUI software of FIG. 3;

FIG. 8 and FIG. 9 are diagrams depicting projection of a 3D model of a passageway to a 2D representation;

FIG. 10 and FIG. 11 are exemplary screens showing movement of a user along a passageway;

FIG. 12 is an exemplary screen showing turning of a user in a passageway;

FIG. 13 and FIG. 14 are exemplary screens showing selection of a thumbnail displayed on a wall panel;

FIG. 15 is an exemplary screen showing a selection being changed;

FIG. 16 is an exemplary screen showing an opened image file being displayed;

FIG. 17, FIG. 18, and FIG. 19 are exemplary screens showing removal of selectable image files;

FIG. 20 is an exemplary screen showing addition of selectable image files;

FIG. 21 is a flowchart depicting exemplary blocks performed at the computing device of FIG. 1;

FIG. 22 is an exemplary screen showing switching from one passageway to another passageway;

FIG. 23 is an exemplary screen showing a parent passageway allowing child passageways to be selected;

FIG. 24 is an exemplary screen showing removal of a child passageway;

FIG. 25 is an exemplary screen showing saving of selectable image files;

FIG. 26, FIG. 27, FIG. 28, FIG. 29, FIG. 30 and FIG. 31 are exemplary screens showing an opened image file being displayed at particular positions and particular viewing angles;

FIG. 32 is an exemplary screen showing an opened image file that moves automatically;

FIG. 33 is an exemplary screen showing switching from one opened image file to another image file;

FIG. 34 is an exemplary screen showing removal of an opened image file; and

FIG. 35 is an exemplary screen showing saving of an opened image file.

### DETAILED DESCRIPTION

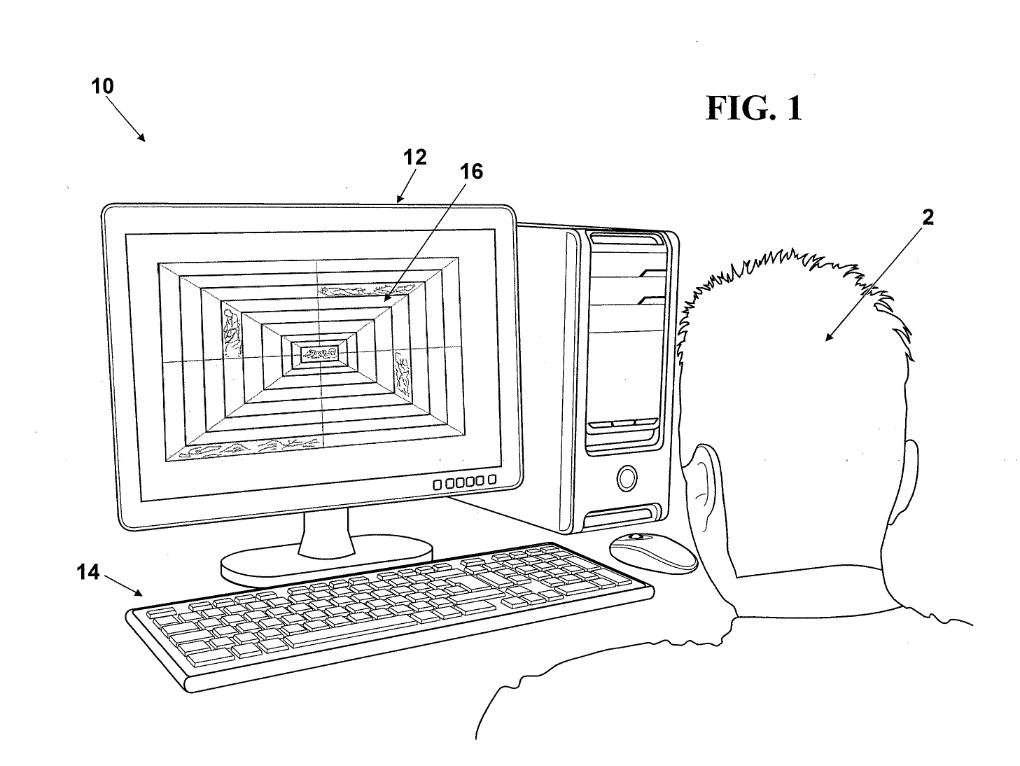

FIG. 1 depicts a computing device 10 adapted to provide a GUI that presents selectable items for selection by a user (eg., user 2) in a user-traversable passageway, exemplary of an embodiment. As depicted, device 10 includes an electronic display 12 displaying an example GUI 16, and user input devices 14 (e.g., a mouse and keyboard) that allow user 2 to provide input to device 10, and thereby interact with GUI 16.

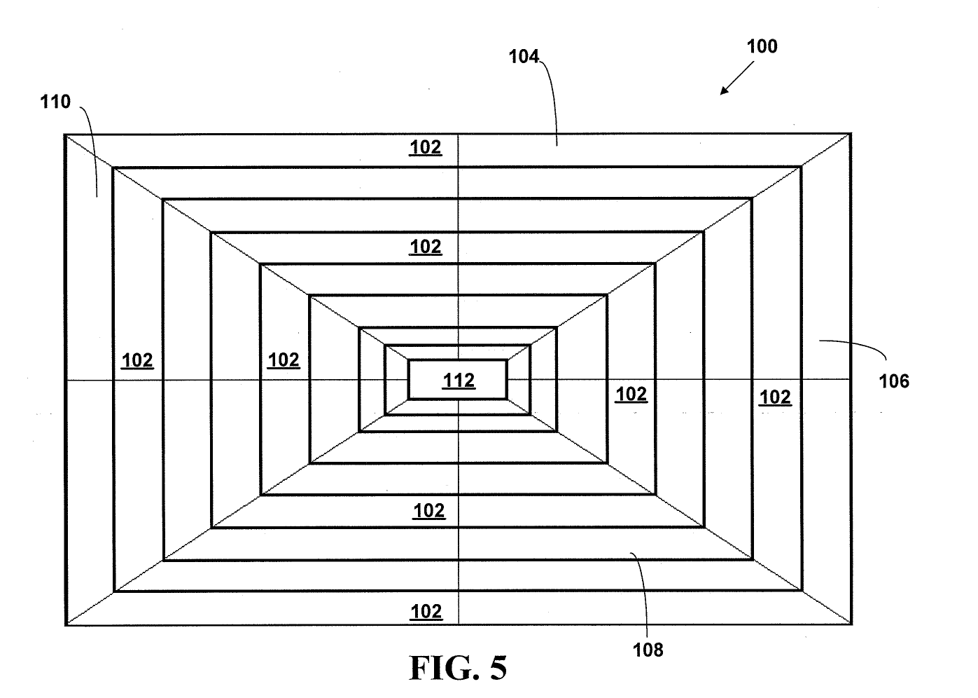

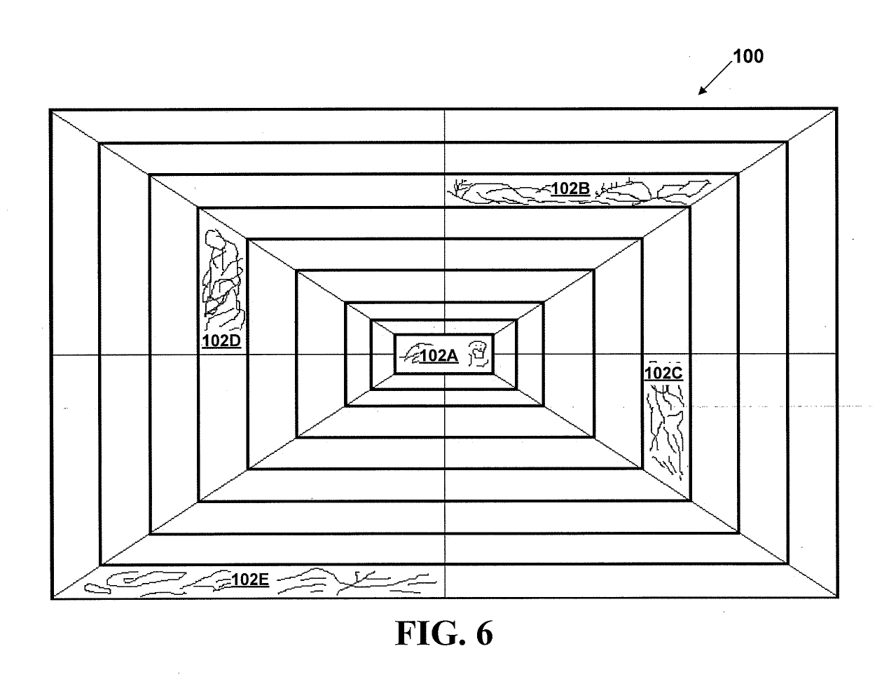

GUI 16 presents selectable items in a user-traversable passageway, such as passageway 100 (FIG. 5 and FIG. 6). In particular, as depicted in FIG. 5, GUI 16 presents a plurality of wall panels 102 forming a graphical representation of a passageway 100 that appears to extend away from user 2 (FIG. 1), with each of wall panels 102 having a panel size commensurate with the apparent distance of that wall panel 102 to user 2. Each one of the selectable items is associated with one of wall panels 102, which displays thereon an image representative of that selectable item. Examples of such images displayed are shown in FIG. 6 on wall panels 102A, 102B, 102C, 102D, 102E.

User 2 may move along the passageway: by issuing a request for movement to device 10, e.g., using an input device 14 or using display 12 when it is a touchscreen display. In response to receiving such a request, device 10 updates GUI 16. In particular, device 10 updates the graphical representation of the passageway in GUI 16 to reflect the movement such that sizes of visible wall panels in the passageway are adjusted to be commensurate with their respective current apparent distances to the user. Thus, GUI 16 allows users such as user 2 to traverse the passageway to view and select the images displayed on each one of the wall panels associated with the selectable items.

User 2 may select an item by selecting the image displayed on a wall panel associated with that item. For example, user 2 may select a displayed image by clicking on the image when one of input devices 14 is a mouse, or by touching the image when display 12 is a touchscreen display.

GUI 16 allows a user such as user 2 to select from among a large number of selectable items. In particular, presenting selectable items using a graphical representation of a passageway allows selectable items to be presented using progressively smaller images (i.e., on wall panels that appear to be progressively farther away from the user), thus increasing the overall number of selectable items that may be simultaneously displayed. Conveniently, all of the images may be displayed simultaneously without occluding any images. Further, presenting selectable items using a graphical representation of a passageway allows the user to move readily towards images for closer inspection. In this way, efficiency of user selection of an item from a large set of items may be improved.

As depicted in FIG. 1, device 10 is a conventional desktop computing device. However, in other embodiments, device 10 may be a laptop computing device. Computing device 10 may also be a mobile computing device, such as a smart-phone, a tablet computer, or an e-book reader, or another type of electronic device such as a set-top-box, a digital video recorder, a gaming console, or a digital television.

Display 12 of device 10 is a conventional display. As depicted, display 12 is a conventional liquid crystal display (LCD) monitor. Display 12 may also be an organic light-emitting diode (OLED) monitor, or a cathode ray tube (CRT) monitor. In some embodiments, display 12 may be a projection display generated by a projector interconnected with or integral to device 10. Display 12 may also be an electronic paper display, e.g., when device 10 is an e-book reader. As noted, display 12 may be a touchscreen display adapted to receive input by contact with fingers or a touch pen.

User input devices 14 are conventional peripheral devices, e.g., a keyboard and a mouse, attached to device 10 by way of conventional interfaces (e.g., serial, USB, or the like). User input devices 14 may be omitted when computing device 10 is adapted to receive user input in other ways, e.g., by way of voice commands or a touchscreen display.

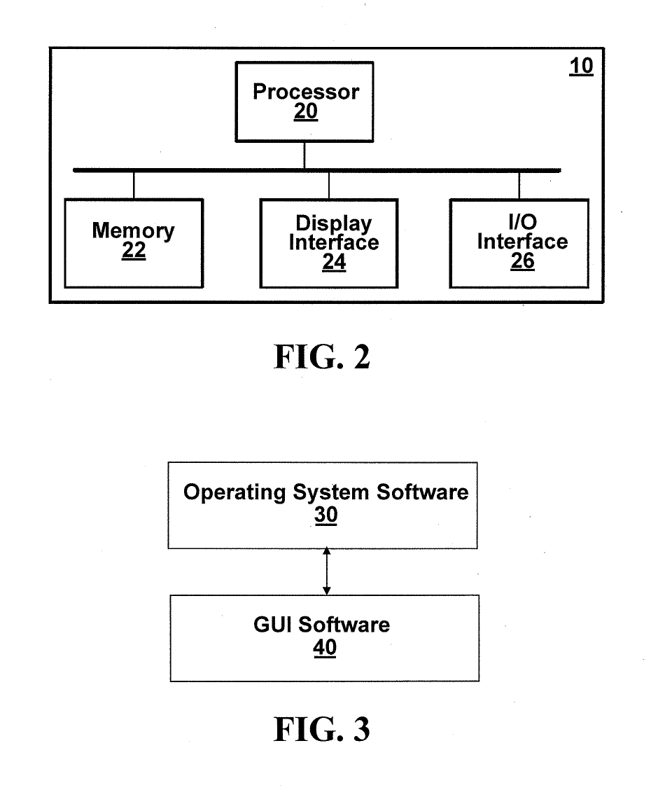

FIG. 2 is a high-level block diagram of computing device 10. As depicted, computing device 10 includes a processor 20, a suitable combination of persistent storage memory 22, random-access memory and read-only memory, a display interface 24 interconnecting device 10 with a display (e.g., display 12), and an I/O interface 26 interconnecting device 10 with I/O devices (e.g., user input devices 14). Processor 20 may, for example, be an Intel x86, ARM, PowerPC processor, or the like. Memory 22 may be organized using a conventional filesystem, controlled and administered by an operating system, discussed below, which governs overall operation of computing device 10. Device 10 may store, through this filesystem, selectable items in memory 22.

In some embodiments, computing device 10 may include a network interface (not shown) interconnecting device 10 to other computing devices by way a network. The network may include wired and wireless links, and may include the public Internet or a private intranet.

FIG. 3 illustrates a simplified organization of example software components stored within memory 22 (FIG. 2) of device 10. As illustrated, these software components include operating system (OS) software 30 and GUI software 40. Computing device 10 executes these software components at processor 20 (FIG. 2) to adapt device 10 to operate in the manners detailed below.

OS software 30 may be, for example, a Windows operating system (e.g., Windows XP, Windows 2000, Windows 7, Windows 8, etc.), a Unix-like operating system (e.g., Linux, FreeBSD, Solaris, OSX, etc.), or the like. OS software 30 may also be a mobile device operating system such as Android, BlackBerry OS, iOS, Windows Phone, or the like. OS software 30 allows GUI software 40 to access processor 20, memory including memory 22, display interface 24, and I/O interface 26, and other components of device 10.

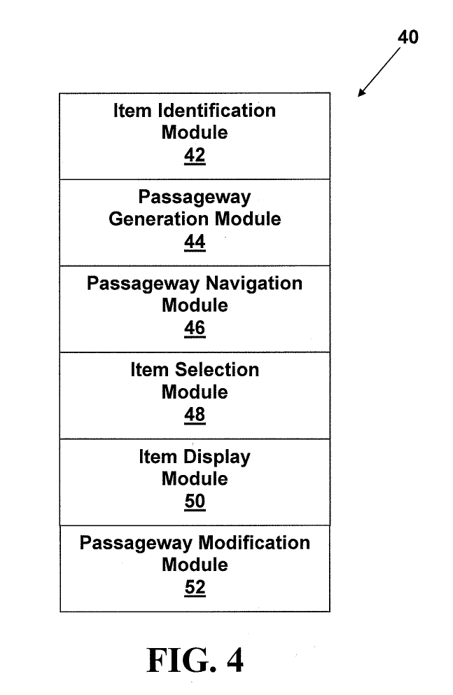

As illustrated in FIG. 4, GUI software 40 includes software modules, including an item identification module 42, a passageway generation module 44, a passageway navigation module 46, an item selection module 48, an item display module 50, and a passageway modification module 52. These software modules may be written using conventional computing languages such as C, C++, C#, Objective C, Ruby, Java, Perl, JavaScript, or Visual Basic. These modules may be in the form of executable applications, scripts, or statically or dynamically linkable libraries.

Each of these software modules are described below with reference to an embodiment of GUI software 40 adapted to allow a user to select from a set of image files. As discussed below, in other embodiments, GUI software 40 may be adapted to allow a user to select from other item types, including, for example, other electronic documents, executable applications, or websites.

Item identification module 42 identifies the set of image files to be presented to the user for selection. In particular, item identification module 42 scans a pre-defined location (e.g., a pre-defined folder) in the filesystem of memory 22 for pre-defined image file types (e.g., jpeg files, tiff files, gif files, or the like). Each image file may be uniquely identified using suitable identifiers, e.g., file name, location, or time stamp.

Passageway generation module 44 generates a graphical representation of a passageway. The passageway may appear as a hallway, a hall, a room, a tunnel, a bridge, or the like. A graphical representation of an example passageway 100 is depicted in FIG. 5. As depicted, the graphical representation of passageway 100 is formed by a plurality of wall panels 102 such that passageway 100 includes a top wall 104, a right wall 106, a bottom wall 108, a left wall 110, and an end wall 112. Optionally, adjacent wall panels may be separated by a gap of a pre-defined size. In the graphical representation, each wall panel 102 is depicted to have a trapezoidal shape, with some wall panels depicted to be shaped as a right trapezoid or an isosceles trapezoid. As discussed below, this trapezoidal shape results from perspective projection of rectangular wall panels in a 3D model to a 2D graphical representation.

In the generated graphical representation, passageway 100 appears to extend away from the user (into the display screen) such that wall panels 102 appear to be at varying distances to a user (e.g., user 2 of FIG. 1). Thus, each of wall panels 102 is displayed at a size commensurate with the apparent distance of the wall panel to the user. In particular, some wall panels 102 are displayed at a smaller size to convey a sense to the user that these wall panels are farther away from the user, while other wall panels 102 are displayed at a larger size to convey a sense to the user that these wall panels are closer to the user.

Each wall panel in a passageway may be associated with an image file in the set of image files to be presented to a user for selection. As such, passageway generation module 44 receives identifiers of each of the image files from item identification module 42. Passageway generation module 44 generates a graphical representation of a passageway having a sufficient number of wall panels to allow each of the selectable items to be associated with a unique wall panel.

The number of wall panels in a single passageway may be limited by available memory (e.g., graphics memory) or other available resources of device 10 required for displaying images on those wall panels. Consequently, the number of selectable image files presentable in a single passageway may be limited to a few thousand, or a few tens of thousands. When the number of image files in the set of image files exceeds this limit, the set of image files may be presented using multiple passageways, as detailed below.

Passageway generation module 44 associates each of the selectable items with an assigned wall panel, and stores this association in memory. Passageway generation module 44 may assign selectable image files to wall panels in a particular order (e.g., an order based on file name, location, date, or another file attribute). Passageway generation module 44 may assign image files to wall panels such that groups of related image files are assigned to adjacent wall panels. Image files may be grouped according to, e.g., file name, location, date, or other file attributes. Image files may be assigned to wall panels randomly. In some embodiments, the wall panel forming an end wall of a passageway (e.g., end wall 112 of passageway 100) may be reserved for one of the selectable image files having a special significance, e.g., an image of a photo album cover, or an image that is representative of the set of selectable image files as a whole.

Passageway generation module 44 generates thumbnails of each image file in the set of image files and displays that thumbnail on the wall panel associated with that image file. For example, FIG. 6 shows passageway 100 of FIG. 5 with thumbnails displayed on wall panels 102A, 102B, 102C, 102D, and 102E. As depicted, some wall panels are not associated with a selectable image file, and thus do not have a thumbnail displayed thereon. However, every wall panel may be associated with a selectable image file such that every wall panel displays a thumbnail. Passageway generation module 44 may display a blank picture or a pre-defined picture on wall panels that are not associated with a selectable image file.

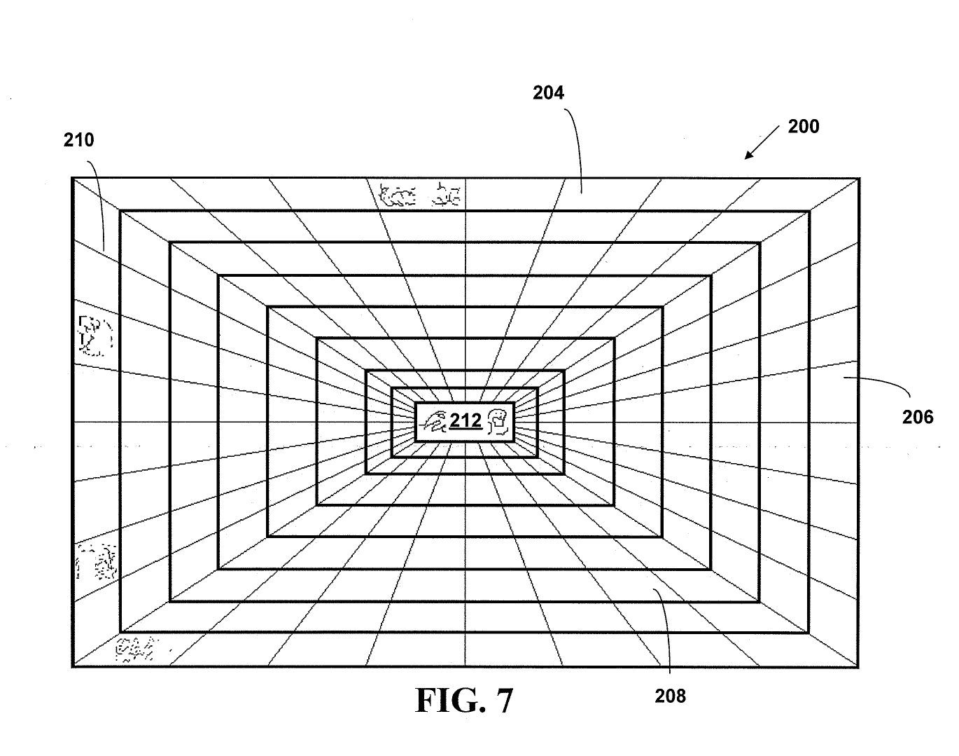

Optionally, the size of wall panels may be adjusted to allow a graphical representation of a passageway to be formed from a fewer or greater number of wall panels, allowing a fewer or greater number of selectable image files to be simultaneously presented. For example, given a large number of selectable items, it may be desirable to reduce the size of wall panels. FIG. 7 shows a passageway 200 in which the size of wall panels forming a top wall 204, a right wall 206, a bottom wall 208, a left wall 210, have been reduced in half compared to the corresponding walls 104, 106, 108, and 110 of passageway 100 (FIG. 5). As a result, twice as many thumbnails may be shown on the wall panels of those walls. The size of some wall panels may remain the same. For example, the size of the wall panel forming an end wall 212 is the same as the size of wall panel forming end wall 112 of passageway 100 (FIG. 5). The size of wall panels may be adjusted during initialization of GUI software 40 based on stored user-preferences, or during operation in response to user commands. One or both of the height and width of wall panels may be adjusted.

To generate a graphical representation of a passageway for display on a two-dimensional (2D) display (e.g., display 12), passageway generation module 44 creates a three-dimensional (3D) model of the passageway and then generates a 2D projection of that 3D model, e.g., using perspective projection. Conventional 3D rendering engines and APIs may be used to create such a 3D model and generate a 2D projection. For example, in one specific embodiment, passageway generation module 44 may use the Direct3D 11 API in conjunction the Axiom 3D Rendering Engine. Other APIs (e.g., OpenGL) and other rendering engines (e.g., Object-Oriented Graphics Rendering Engine or “OGRE”) suitable for generating and displaying 3D environments may also be used. Conventional techniques for generating and displaying 3D environments in 3D gaming software may be applied to generate the graphical representations of passageways in GUI 16.

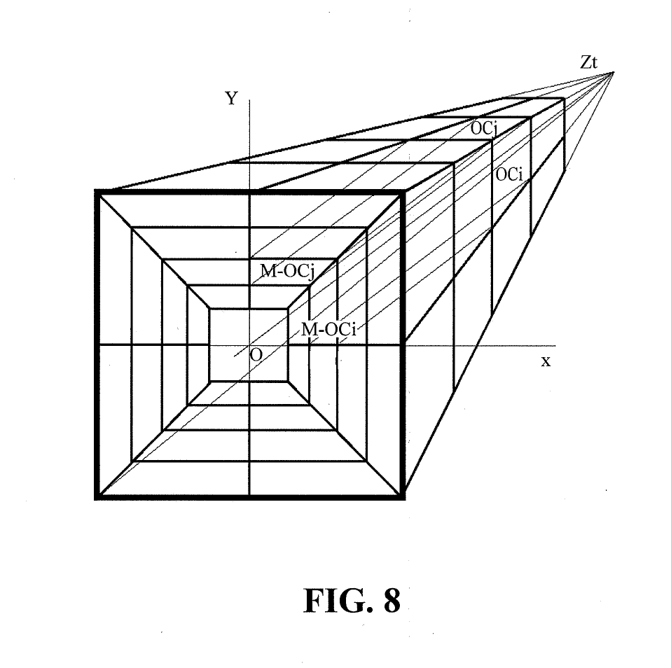

FIG. 8 depicts an example 3D model of a passageway that extends along axis Zt. A 2D projection of this 3D model is shown at plane X-Y. Each of the wall panels is projected from the 3D model to the 2D graphical representation, including any thumbnails displayed on those wall panels.

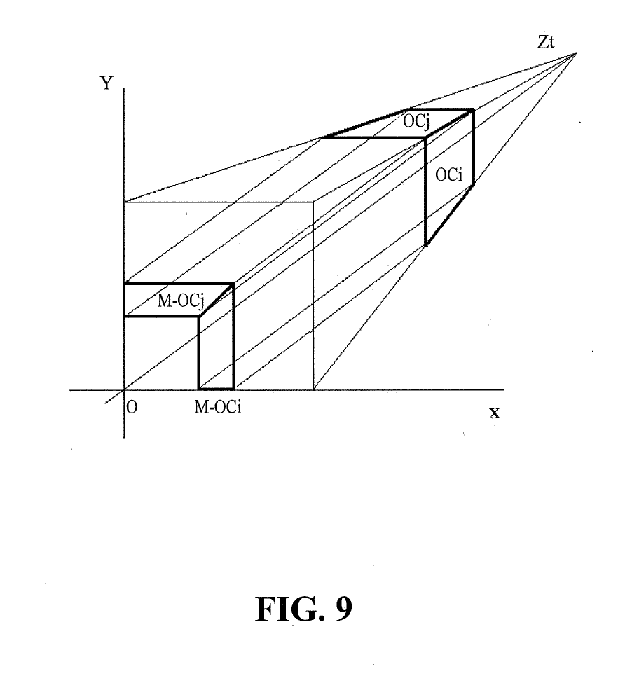

For example, as depicted in FIG. 8, a wall panel OCi in the 3D model is projected to wall panel M-OCi in the 2D graphical representation. Similarly, a wall panel OCj in the 3D model is projected to wall panel M-OCj in the 2D graphical representation. FIG. 9 depicts a simplified view of this projection that includes only the top-right quadrant of the passageway.

As will be appreciated, although all wall panels in the 3D model may have the same panel size, in the 2D graphical representation, each of wall panels 102 is displayed at a size commensurate with the apparent distance of the wall panel to the user. Further, although wall panels in the 3D model are rectangular, wall panels are depicted to be trapezoidal in shape in the 2D graphical representation following perspective projection.

The shape of the wall panels in the 3D model may be selected to suit the shape of images to be displayed thereon. So, for example, rectangular wall panels may be selected to display rectangular images. Of course, rectangular images are also depicted to be trapezoidal in shape in the 2D graphical representation following perspective projection.

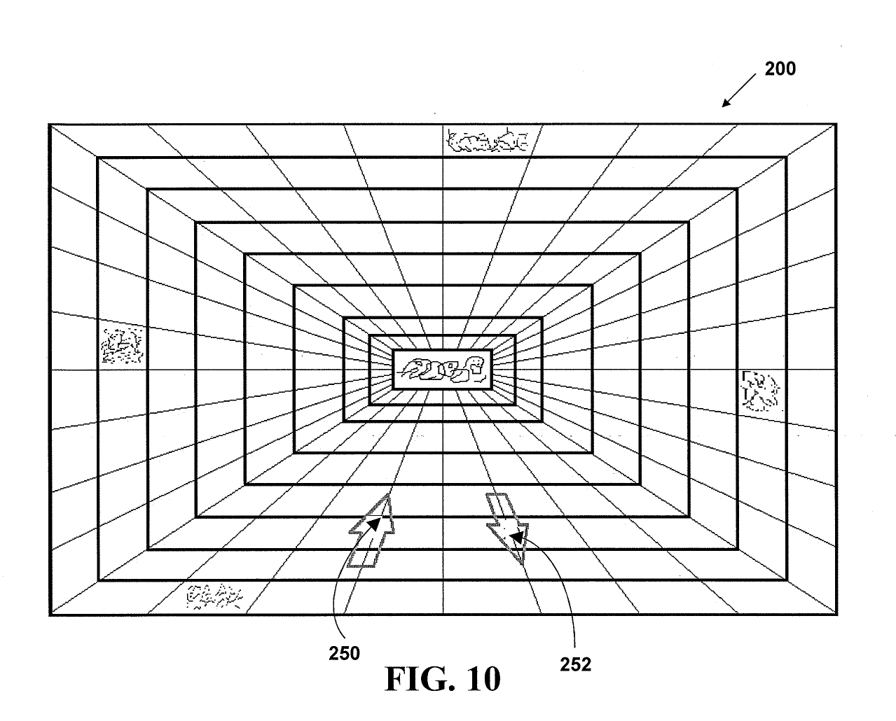

Passageway navigation module 46 allows a user to traverse a passageway to view thumbnails presented on each of the wall panels associated with a set of selectable image files. For example, as illustrated in FIG. 10, a user may traverse passageway 200 by moving in a forward direction 250 or a rearward direction 252.

Passageway navigation module 46 receives user input reflective of a request to move along a passageway in a particular direction. Passageway navigation module 46 processes the received input to determine the direction of the requested movement. For example, input indicative of an upward scroll of a mouse-wheel, an upward swipe on a touchscreen display, or a press of a pre-defined key on a keyboard, or the like, may be processed to determine that a user is requesting movement in a forward direction along a passageway. Similarly, input indicative of a downward scroll of a mouse-wheel, a downward swipe on a touchscreen display, or a press of a different pre-defined key on a keyboard, or the like, may be processed to determine that a user is requesting movement in a rearward direction along a passageway.

In response to receiving a user request for movement, passageway navigation module 46 updates the graphical representation of the passageway to reflect the requested movement. The graphical representation of the passageway may be updated by generating a new 2D projection of the 3D model of the passageway from the new user position after the movement. In the updated graphical representation of the passageway, the sizes of visible wall panels in the passageway are adjusted to be commensurate with their respective new apparent distances to the user.

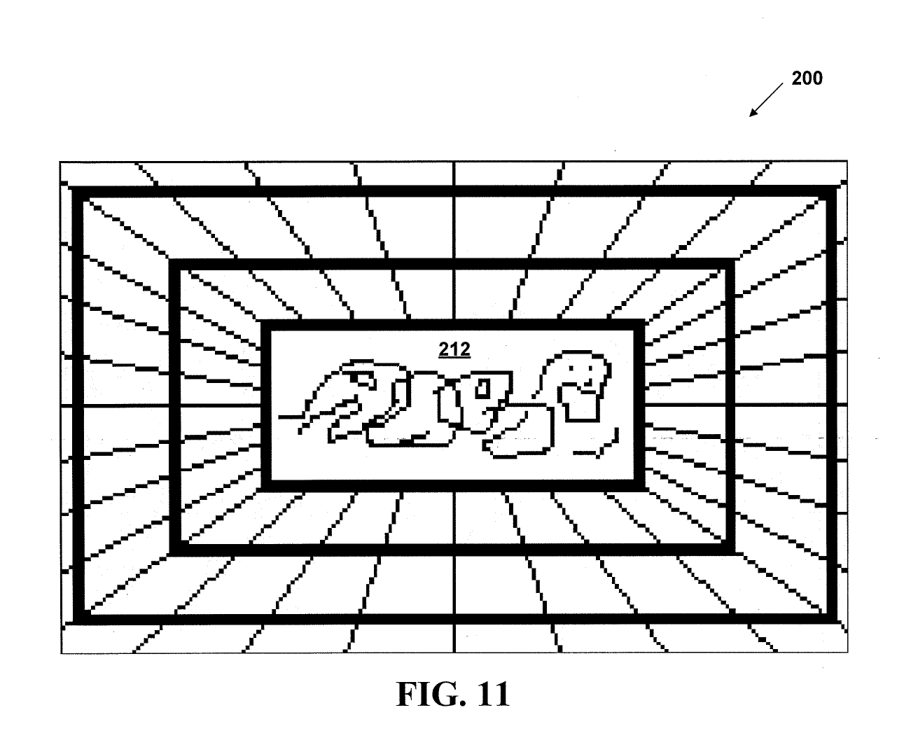

For example, FIG. 11 shows a graphical representation of passageway 200 after a user has moved forward along passageway 200 to be near end wall 212. The sizes of the wall panel forming end wall 212 and surrounding wall panels, as depicted in FIG. 11 are larger than sizes of the corresponding wall panels as depicted in FIG. 5, reflective of user movement bringing the user closer to those wall panels. Moving forward along a passageway causes a user to move past some wall panels, which then disappear from view along with any thumbnails displayed thereon. In this way, wall panels displaying thumbnails that a user has already viewed may be removed from view. Consequently, more screen space is made available to display thumbnails on wall panels in front of the user in the passageway.

A user may control the speed of movement along a passageway. For example, a user may request to move along a passageway such that each request for movement causes the user to move a particular distance. Conveniently, high speed movement along a passageway allows a user to quickly view a large number of thumbnails for a large number of selectable image files. Optionally, a user may request to move directly (i.e., jump) to a particular location in a passageway.

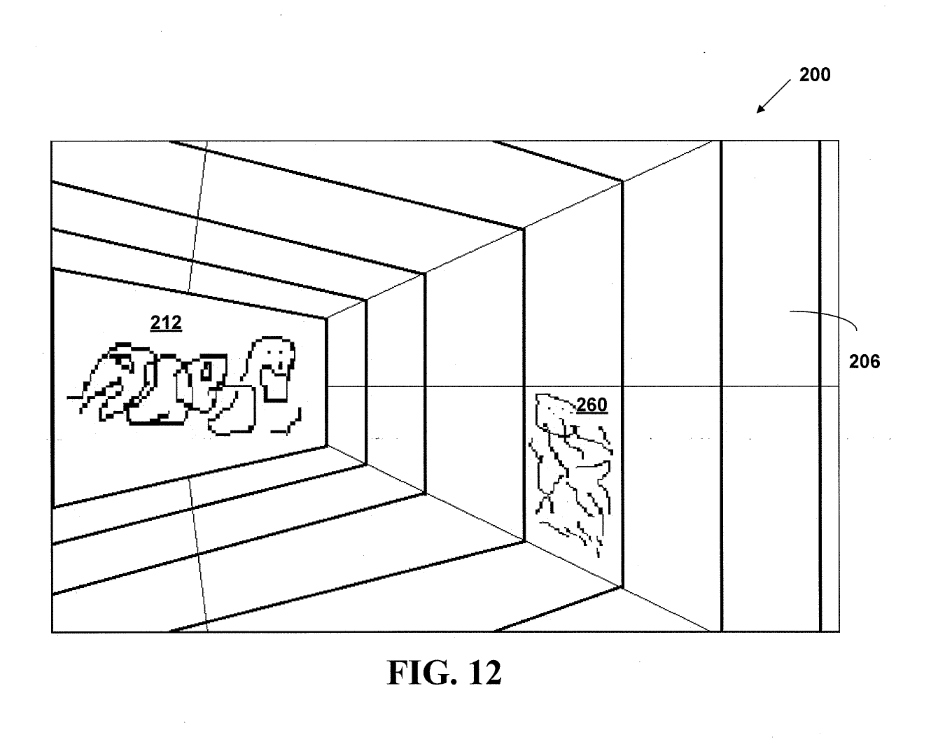

Passageway navigation module 46 allows a user to turn towards a side wall for closer inspection of a thumbnail shown on a wall panel of that side wall. For example, FIG. 12 shows a graphical representation of passageway 200, after a user has turned towards right wall 206. A user may also request to turn back, i.e., to directly face end wall 212. A user may request a turn by issuing input, e.g., by way of a user input devices 14 or a touchscreen display. In response to receiving such user input, passageway navigation module 46 updates the graphical representation of the passageway to reflect the requested turn.

Item selection module 48 allows a user to select a thumbnail displayed on any visible wall panel, and then open the picture represented by that thumbnail for viewing.

A user may select a particular thumbnail by clicking on its location on a display or by touching its location on a touchscreen display. In response to receiving input indicative of a location, item selection module 48 determines the wall panel displayed at that location. This determination may be performed based on a mapping that is the inverse of the 3D-to-2D projection discussed above with reference to FIG. 8 and FIG. 9. This mapping may, for example, be implemented as a function that converts pixel coordinates on a display to a wall panel location in the 3D model or a wall panel identifier. This mapping may take into account the current display resolution, the current display orientation (e.g., landscape or portrait), the shape of the wall panels, the shape of the passageway, etc.

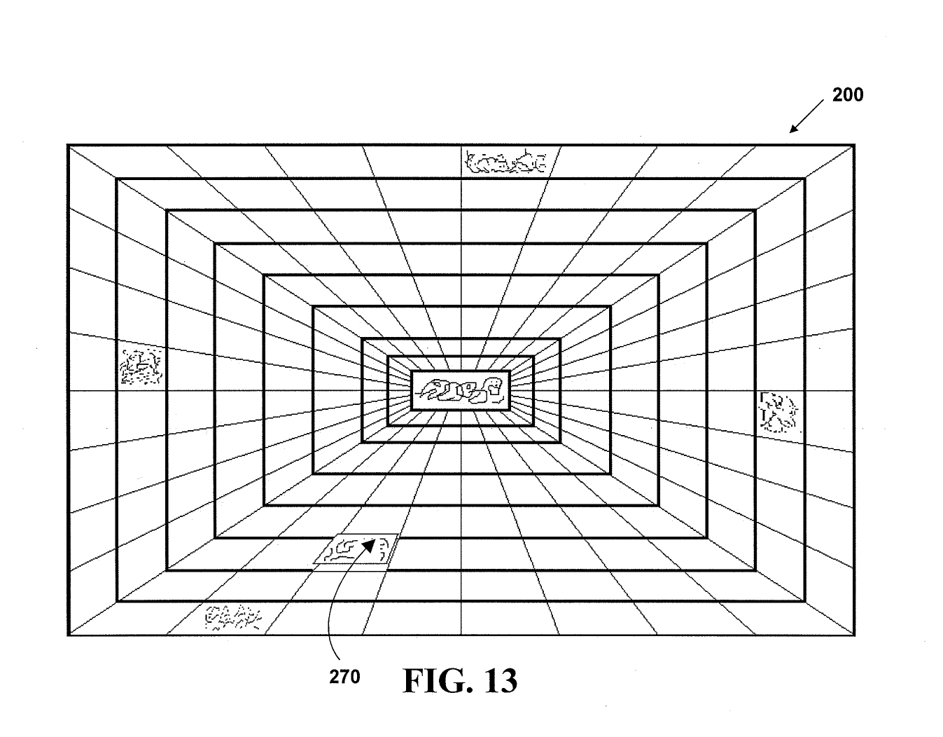

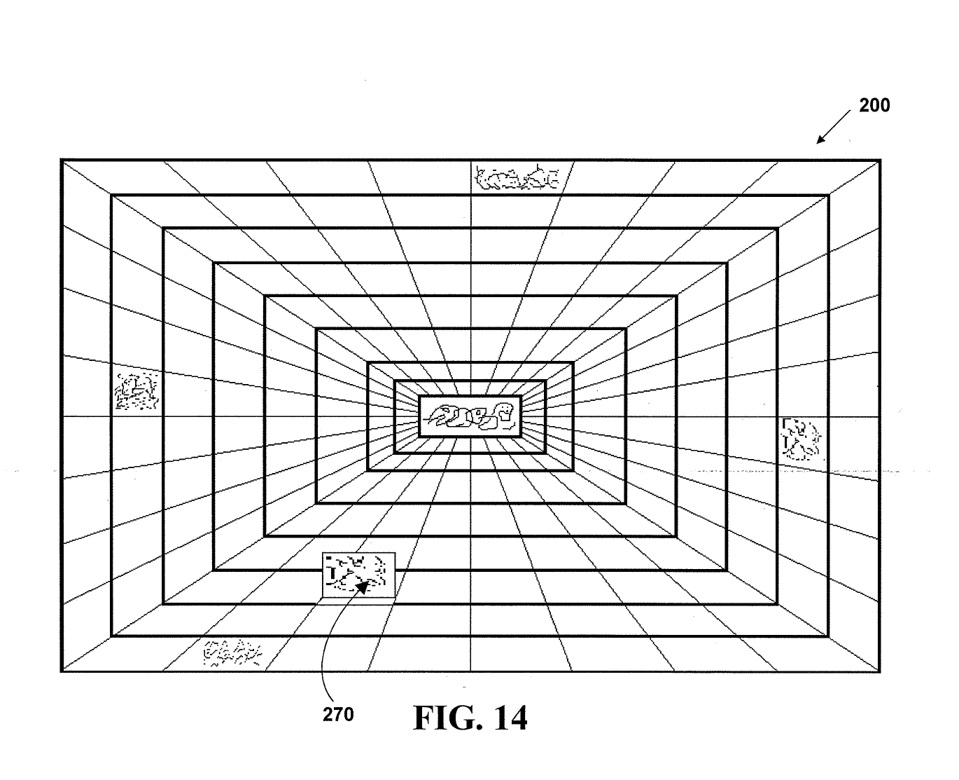

Once item selection module 48 determines that a user has selected a thumbnail displayed on a particular wall panel (also referred to as the selected panel or the active panel), item selection module 48 updates the graphical presentation of a passageway to show that the particular wall panel (and associated item) has been selected. For example, as shown in FIG. 13, item selection module 48 may update the graphical presentation of passageway 200 to show a wall panel 270 displaying a selected thumbnail that floats away from adjacent wall panels. Alternatively, as shown in FIG. 14, item selection module 48 may update the graphical presentation of passageway 200 to show the selected (active) wall panel 270 flipped toward the user (e.g., to be parallel to the user), and thereby cause the thumbnail displayed on wall panel 270 to be rotated to face the user. This allows the user to view directly the thumbnail displayed on wall panel 270. The graphical representation may also be updated to adjust the brightness or colour of the selected thumbnail, or otherwise highlight the selected thumbnail. Updating the graphical representation in such manners allows the selected thumbnail to be readily distinguished from unselected thumbnails.

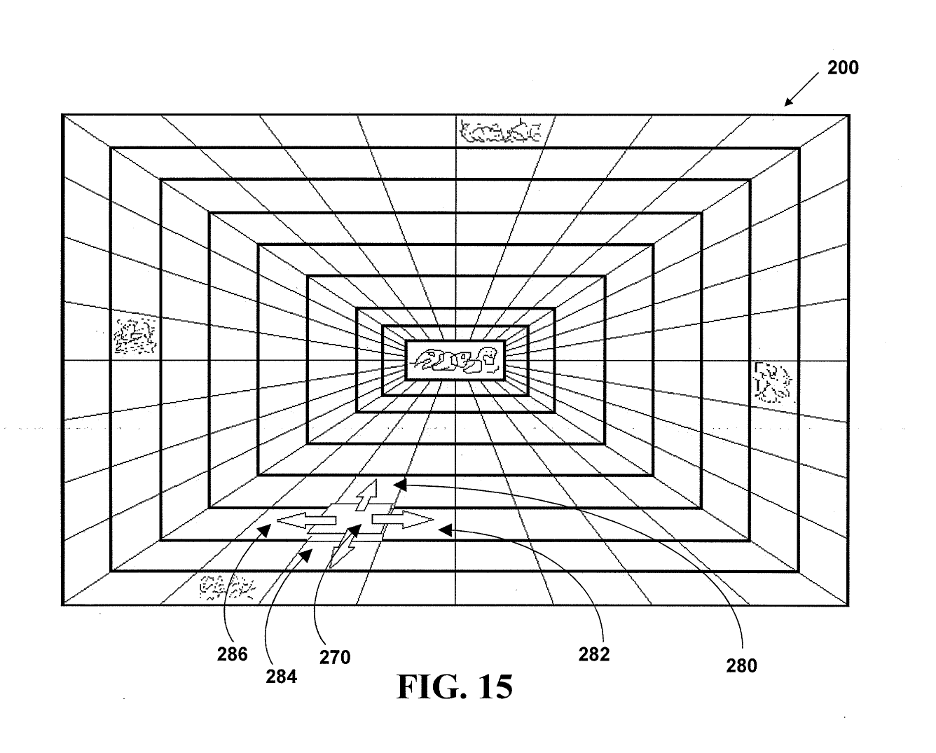

After a thumbnail displayed on a particular wall panel has been selected, item selection module 48 allows the user to change the selection easily to a thumbnail displayed on an adjacent thumbnail. In particular, the user may change the selection by requesting that the selection be moved in a particular direction. For example, as illustrated in FIG. 15, after the thumbnail displayed on wall panel 270 is selected, the user may request that the selection be moved forward to select wall panel 280, rightward to select wall panel 282, rearward to select wall panel 284, or leftward to select wall panel 286.

Selecting a thumbnail may cause any previously selected thumbnail to become de-selected. De-selecting a thumbnail causes the graphical representation of a passageway to be updated to restore the position of the wall panel displaying that thumbnail, or to restore the brightness or colour of that thumbnail, if changed at the time the thumbnail was selected.

Once a thumbnail displayed on a particular wall panel has been selected, the user may request specific actions to be performed for the image file associated with the particular wall panel, namely, the selected image file. For example, as detailed below, the user may request that the selected image file be opened (activated) for display, removed from GUI 16, or saved to a user-specified location.

Item display module 50 allows a user to open an image file after its thumbnail has been selected. Specifically, once a user has selected a thumbnail displayed on a particular wall panel, as described above, the user may request to open the image file associated with that wall panel. For example, a user may request to open the image file by double-clicking on a selected thumbnail, or using a defined gesture on a touchscreen display. Item display module 50 identifies the image file to be opened based on the associations between wall panels and image files stored in memory by passageway generation module 44. For example, the following table shows examples of a few of such associations for passageway 200:

| Wall Panel | Image File |
|---|---|
| 270 | 300 |
| 280 | 302 |
| 282 | 304 |
| 284 | 306 |
| 286 | 308 |

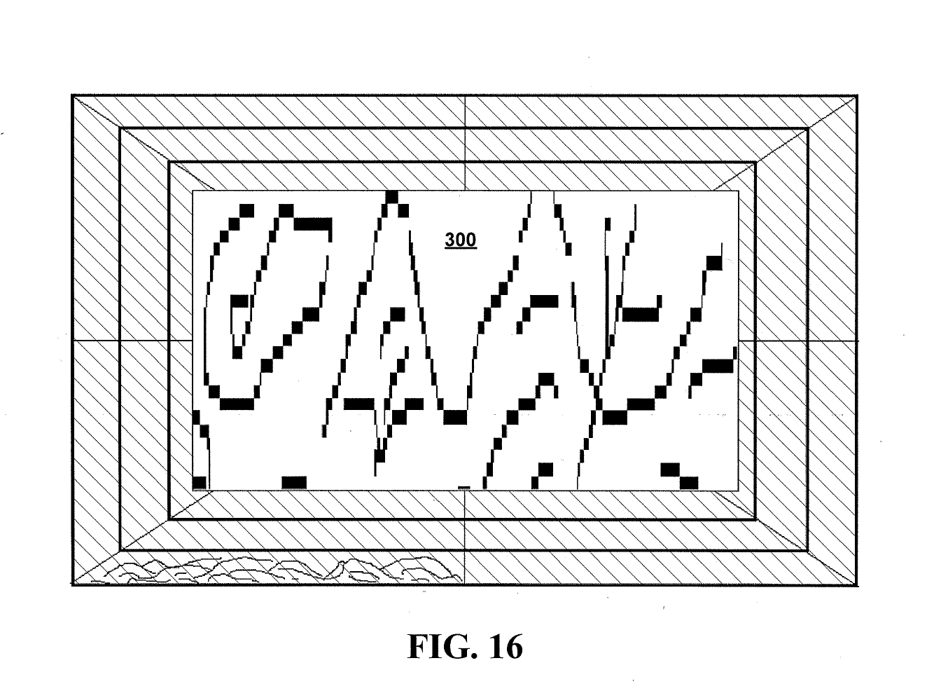

So, for example, when the user selects the thumbnail displayed on wall panel 270 (FIG. 13) and requests to open its associated image file, item display module 50 identifies the associated image file as image file 300. Item display module 50 then loads image file 300 from memory 22 and displays it on display 12. For example, FIG. 16 depicts image file 300 displayed after it has been opened. As depicted, image file 300 is displayed centrally. Image file 300 may be displayed over the graphical representation of passageway 200, with passageway 200 dimmed to focus user attention on the displayed image file. Image file 300 may also be displayed to span all of display 12, or span an application window on display 12.

Passageway modification module 52 allows a user to modify the set of image files, namely, to add or remove image files, presented in GUI 16 to a user for selection.

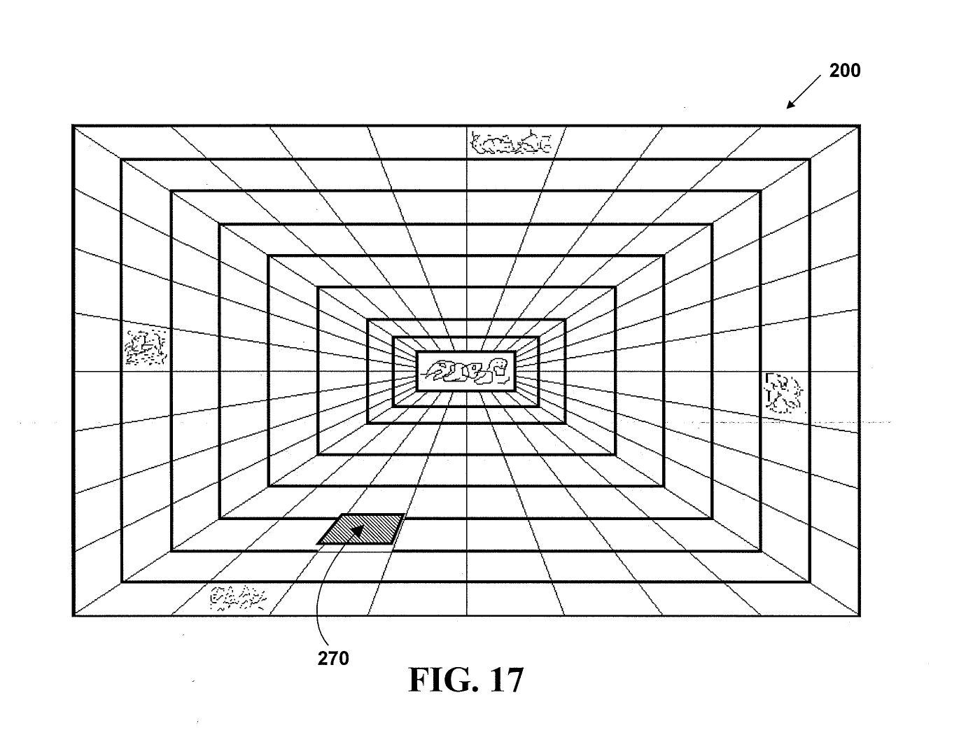

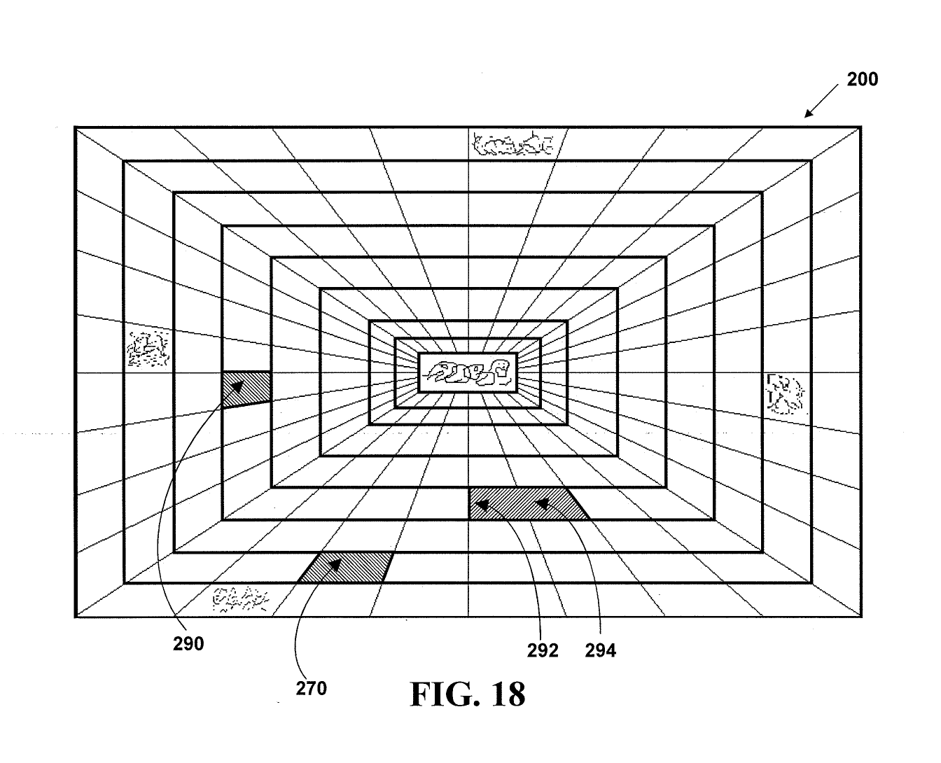

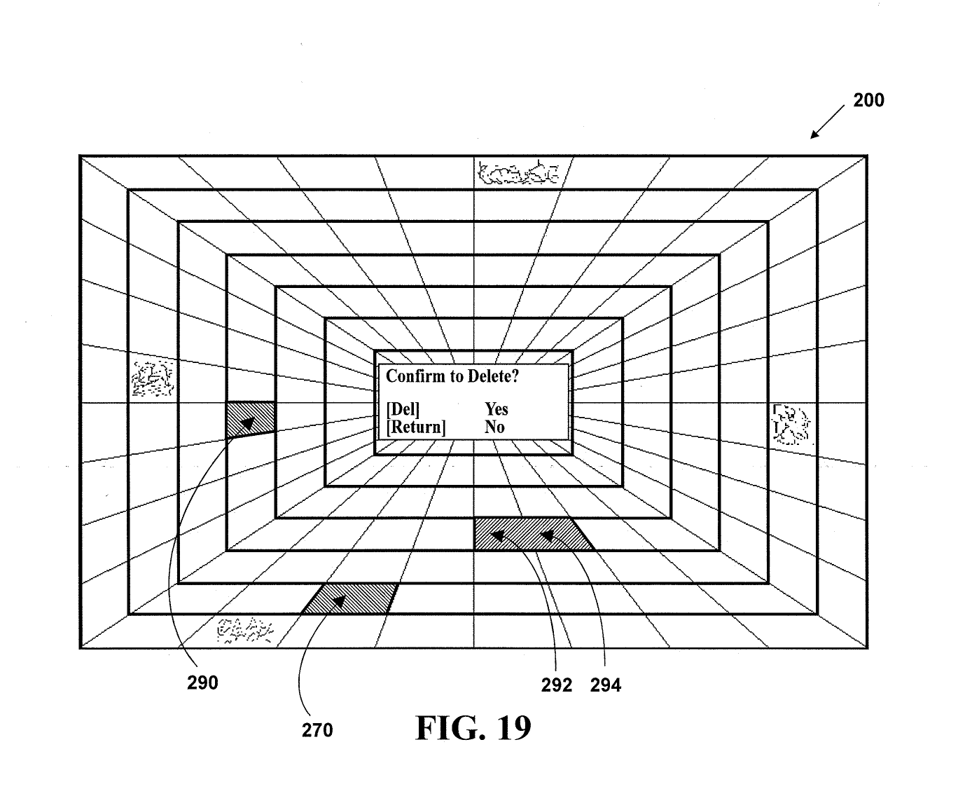

In particular, once a user has selected a thumbnail displayed on a particular wall panel, the user may request to remove the image file associated with the particular wall panel from GUI 16. In response, passageway modification module 52 removes the image file from GUI 16 by deleting the association between the image file and its wall panel from memory, and updating the graphical representation of the passageway such that the formerly associated wall panel no longer displays the thumbnail. For example, FIG. 17 depicts a wall panel 270 associated with an image file selected by a user for removal. A user may select multiple image files for simultaneous removal. For example, FIG. 18 depicts wall panels 270, 290, 292, and 294 associated with respective image files selected by a user for removal. Passageway modification module 52 may prompt the user for confirmation before removing any image files, as depicted in FIG. 19.

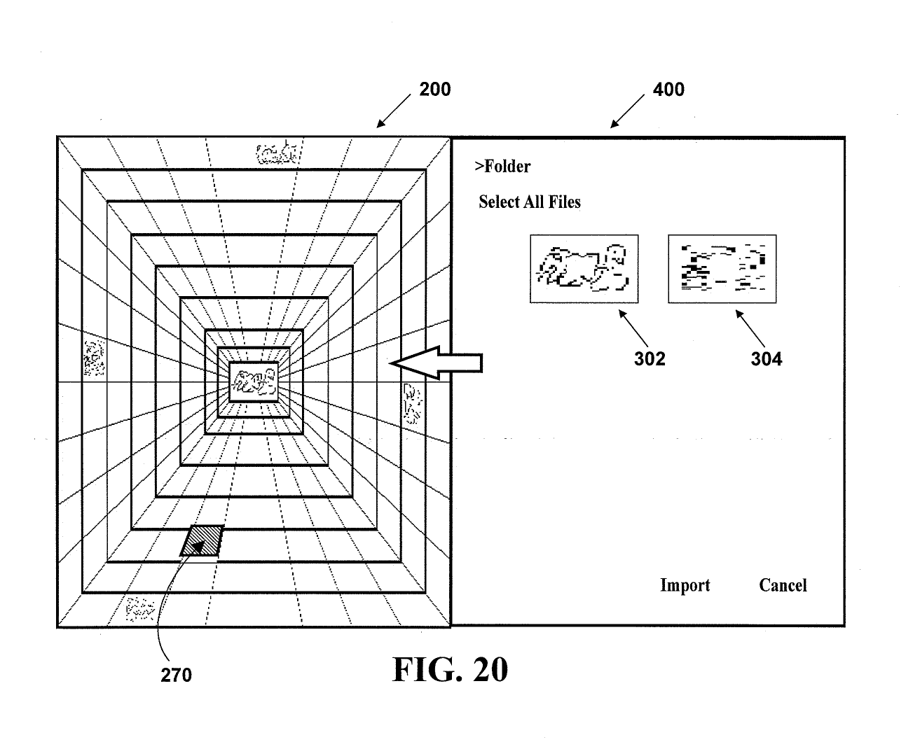

Passageway modification module 52 also allows a user to manually add selectable image files to GUI 16. In response to a user request to manually add selectable images files, passageway modification module 52 presents a dialog box prompting a user to identify one or more image files, e.g., stored in the filesystem of memory 22, to be added. For example, FIG. 20 illustrates a dialog box 400 presented beside a graphical representation of passageway 200. As depicted, a user has requested that image files 302 and 304 be added to the set of selectable image files presented in GUI 16. Each added image file is associated with a wall panel in the passageway in manners described above. A user may request to manually add the same selectable image file multiple times and associate that image file with multiple wall panels. In this way, the same selectable image file may be presented multiple times within a passageway.

Optionally, an added image file may replace an existing image file. For example, when a user requests a new image file to be added to GUI 16 when an existing image file has been selected, the existing image file may be removed from GUI 16. The new image file is then associated with the wall panel formerly associated with the removed image file.

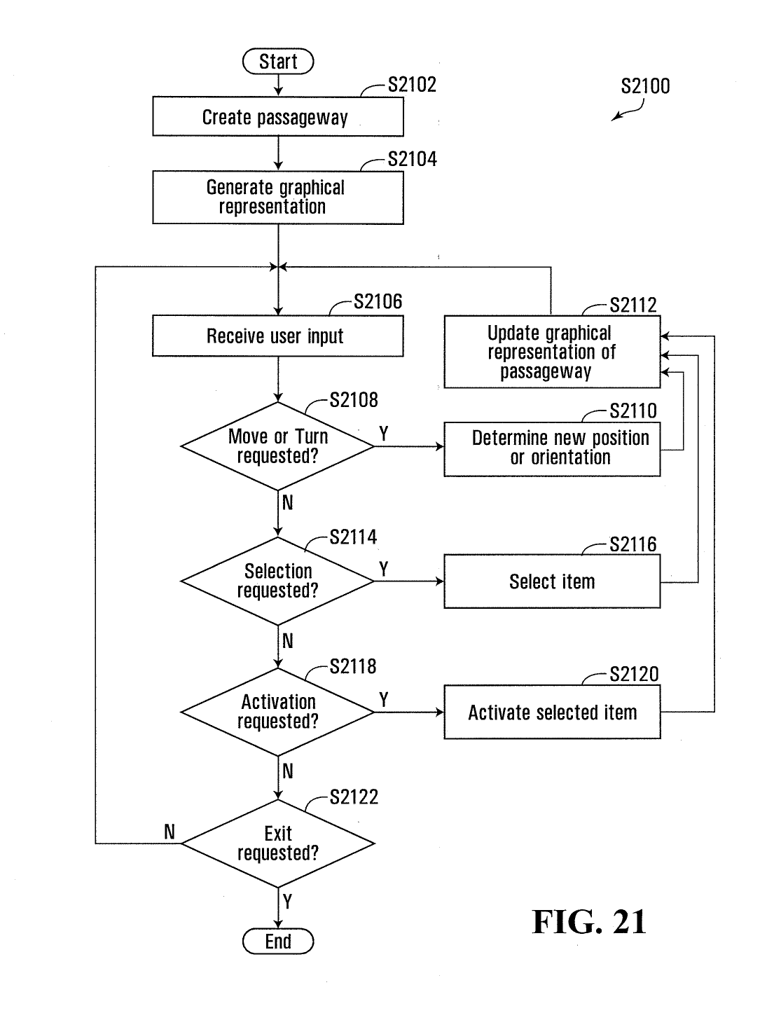

The operation of GUI software 40 is further described with reference to FIG. 21, which depicts a flowchart of steps performed by GUI software 40 at device 10. GUI software 40 performs steps shown in blocks S2100 and onward to present a GUI as described herein that allows a user to select an image from a set of selectable images.

At block S2102, item identification module 42 of GUI software 40 identifies a set of image files to be presented to a user for selection. Passageway generation module 44 of GUI software 40 then creates a 3D model of a passageway formed by a plurality of wall panels, and associates each of the set of image files with one of the wall panels.

At block S2104, passageway generation module 44 generates a 2D projection of the 3D model to form a graphical representation of the passageway. As noted, in this graphical representation, the passageway appears to extend away from the user such that each of the wall panels has a panel size commensurate with the apparent distance of the wall panel to the user. Further, a thumbnail representation of each of the image files is shown on the wall panel associated with that image file. This 2D graphical representation of the passageway is presented to the user on display 12.

At block S2106, user input is received, e.g., by way of one of user input devices 14 or display 12 when it is a touchscreen display, and is processed. If the user input is determined at block S2108 to be a request to move along the passageway or turn in passageway, the request is serviced by passageway navigation module 46. In particular, at block S2110, passageway navigation module 46 calculates a new position or orientation for the user reflective of the requested movement or turn. Thereafter, the graphical representation of the passageway is updated at block S2112 to reflect the new position or orientation of the user. If the user has moved to a new position , the sizes of visible wall panels in the passageway are adjusted to be commensurate with their respective current apparent distances to the user. GUI 16 then waits for further user input.

If the user input received at block S2106 is determined at block S2114 to be a request to select one of the selectable image files, the request is serviced by item selection module 48. In this case, at block S2116, item selection module 48 identifies the particular wall panel displaying the thumbnail that has been selected (e.g., clicked or touched) by the user. Thereafter, the graphical representation of the passageway may be updated at block S2112 to reflect this selection, e.g., by flipping the wall panel towards the user or otherwise highlighting the wall panel. GUI 16 then waits for further user input.

If the user input received at block S2106 is determined at block S2118 to be a request to activate the selected image file, the request is serviced by item display module 50. In this case, at block S2120, item display module 50 activates (opens) the image file previously selected at block S2116. In particular, item display module 50 loads the selected image file from memory 22, and then displays the selected image file on display 12, e.g., by updating the graphical representation of the passageway at block S2112 to display the image file overlaid thereon. GUI 16 then waits for further user input, e.g., to view, select and activate further image files.

If the user input received at S2106 is determined at block S2122 to be a request to exit GUI 16, execution of GUI 16 terminates.

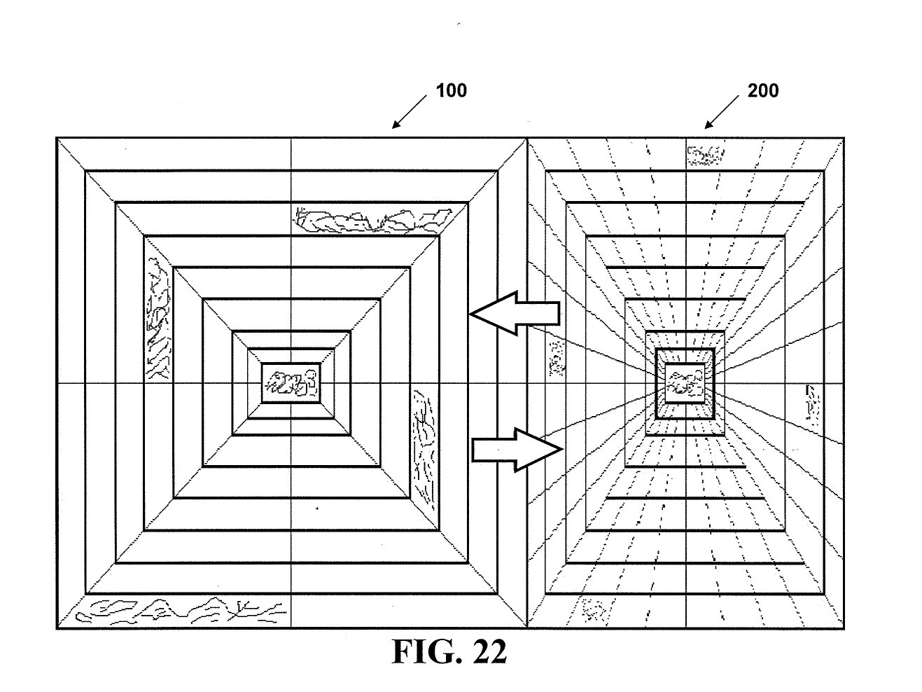

In an embodiment, passageway generation module 44 may generate multiple passageways to present selectable images files such that each passageway presents a subset of the selectable image files. Generating multiple passageways allows selectable image files to be organized by passageway, e.g., by image content or by image file location. In this embodiment, passageways are presented to the user one at a time, but the user may request to switch from one passageway to another. FIG. 22 depicts, for example, switching from passageway 100 to passageway 200.

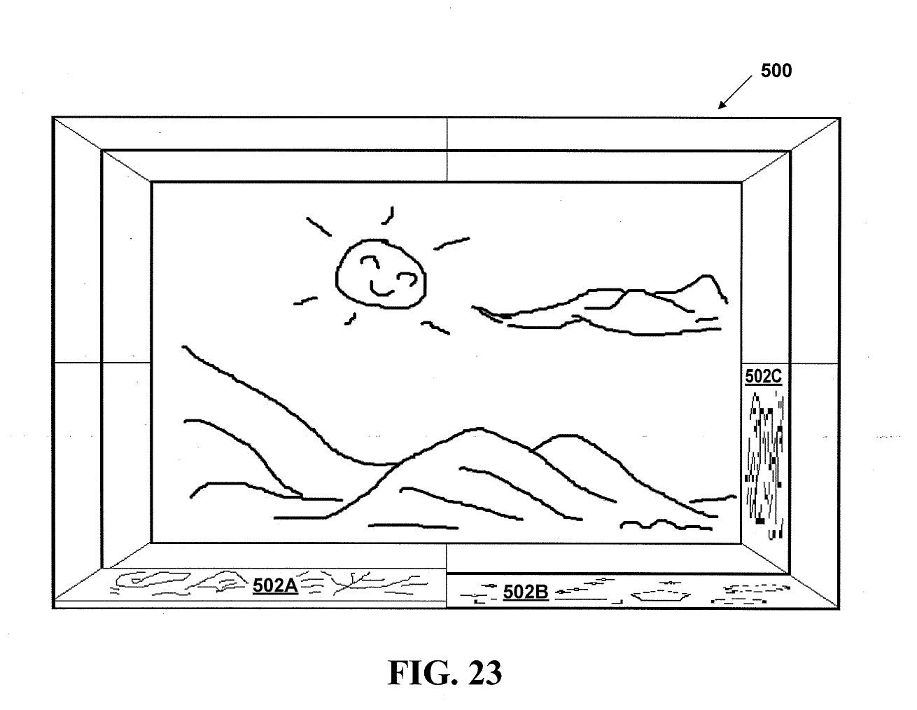

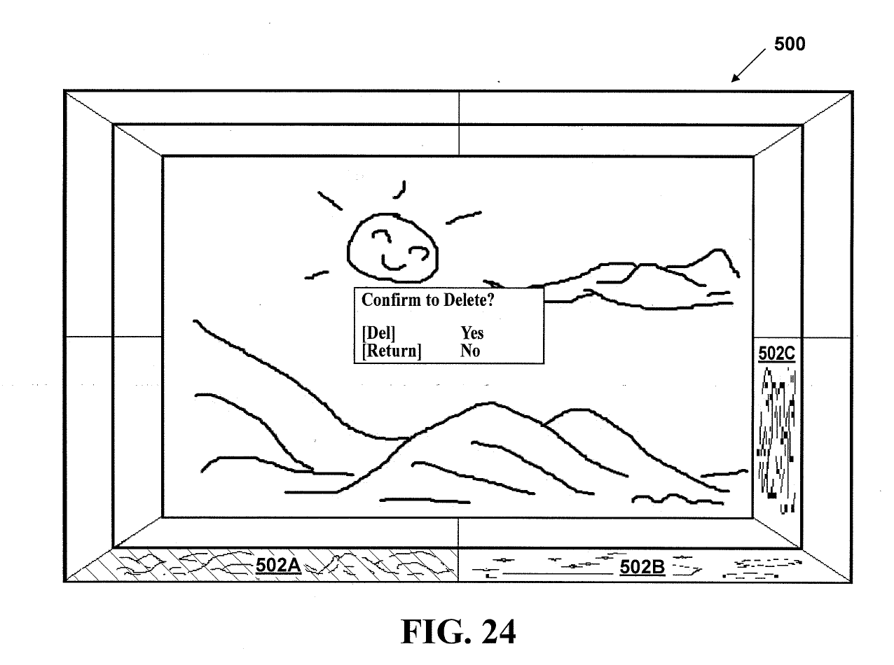

In this embodiment, passageway generation module 44 may also generate a parent passageway in which each wall panel is associated with a child passageway presenting a subset of selectable image files. Each wall panel associated with a child passageway may display an image representative of the subset of selectable image files presented in the associated child passageway. When the user is in the parent passageway, selecting a child passageway causes the user to move from the parent passageway to the selected child passageway to view and select the selectable image files presented therein. For example, FIG. 23 depicts a parent passageway 500 in which each of wall panels 502A, 502B, and 502C is associated with a respective child passageway presenting a subset of the selectable image files. Parent passageway 500 allows selectable image files presented in a particular child passageway to be manipulated collectively. For example, as depicted in FIG. 24, all of the image files presented in a child passageway (e.g., the child passageway associated with wall panel 502A) may be removed from GUI 16 by selecting that passageway, and requesting its removal.

In an embodiment, after a selectable image file has been removed in response to a user request, passageway modification module 52 automatically redefines associations between remaining selectable image files and wall panels such that the remaining selectable image files are associated with contiguous wall panels. The passageway may be also shortened by removing unassociated wall panels at one or both ends of the passageway, and the graphical representation of the passageway may be updated accordingly.

In an embodiment, after a selectable image file has been removed in response to a user request, passageway modification module 52 automatically deletes that image file from the filesystem of memory 22. In this way, GUI 16 may be conveniently used as a file management tool.

In an embodiment, item selection module 48 allows multiple thumbnails displayed on multiple wall panels to be simultaneously selected.

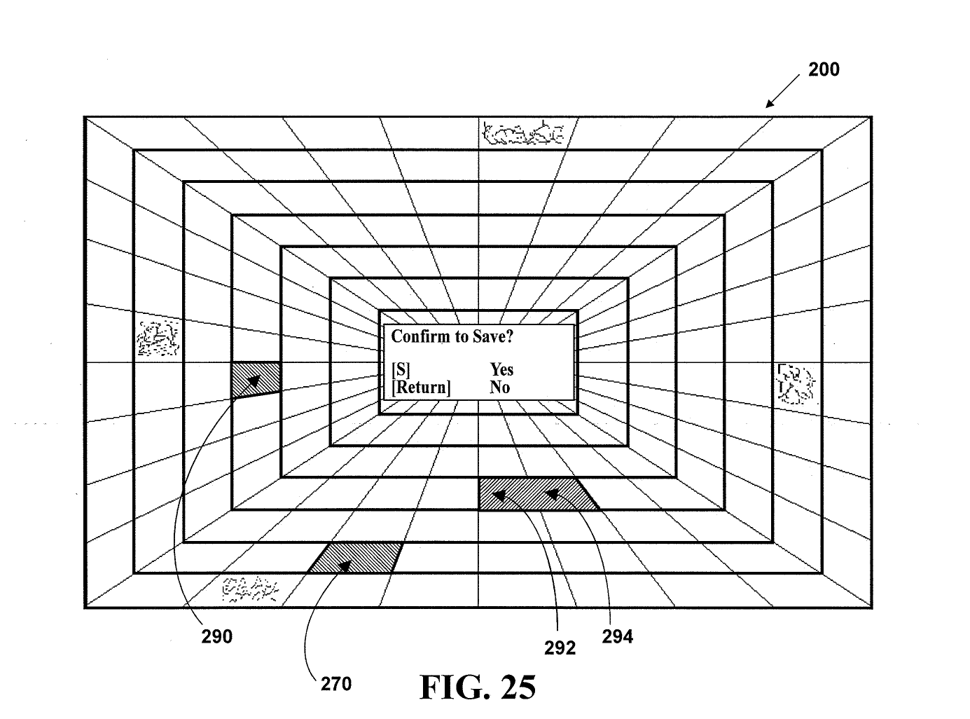

In an embodiment, item selection module 48 allows selectable image files to be saved to a user-specified location in the filesystem of memory 22. In particular, once a user has selected one or more thumbnails displayed on particular wall panels, the user may request to save the image files associated with those wall panels. Item selection module 48 may prompt the user for confirmation before saving any image files, as depicted in FIG. 25.

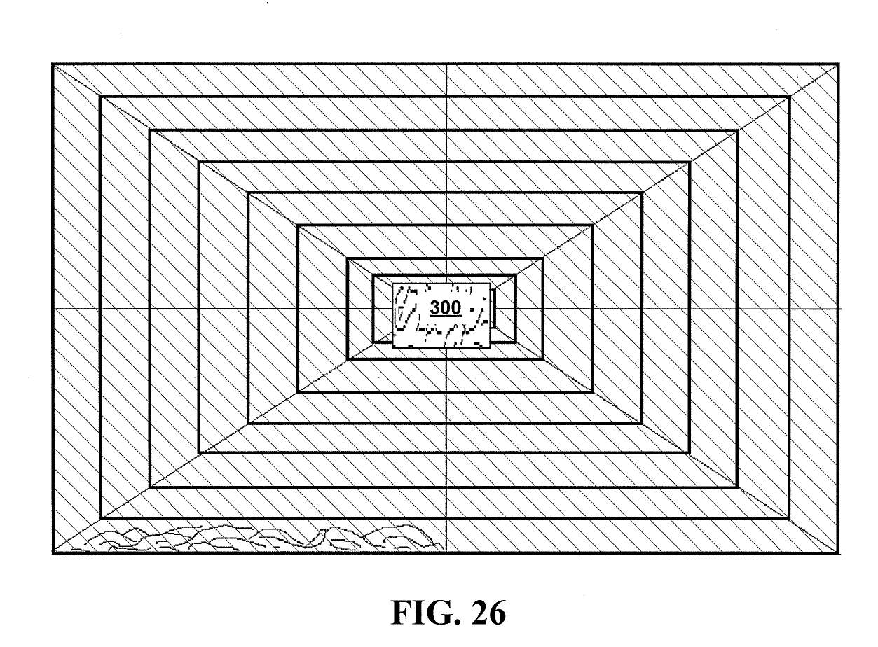

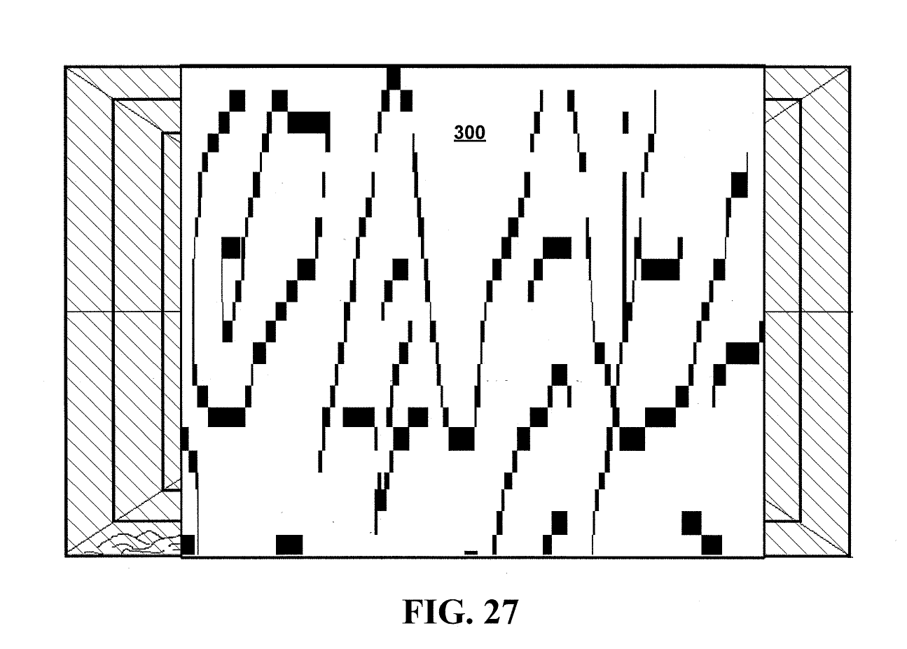

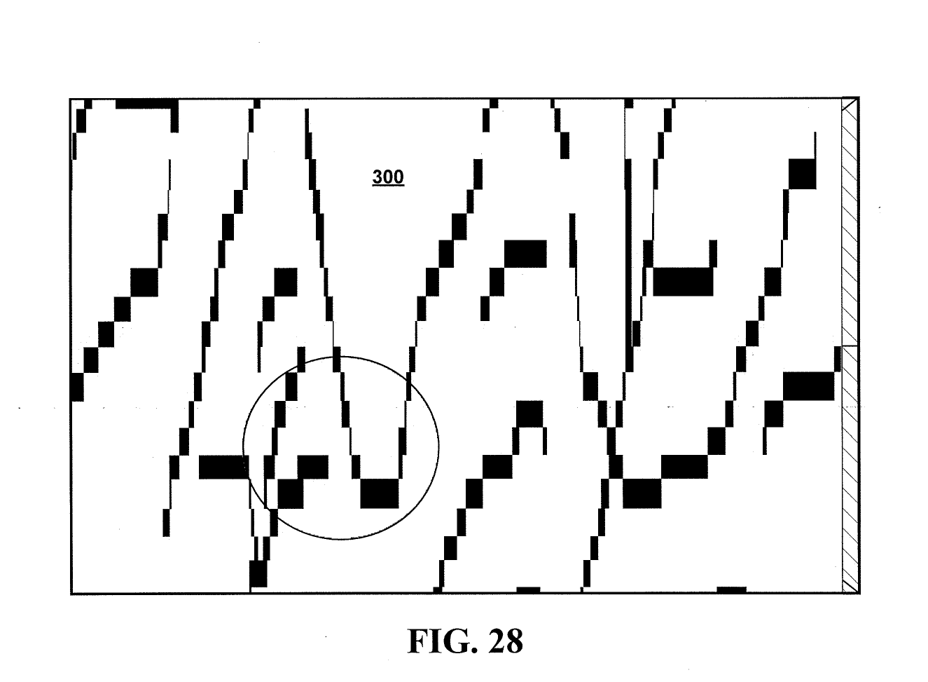

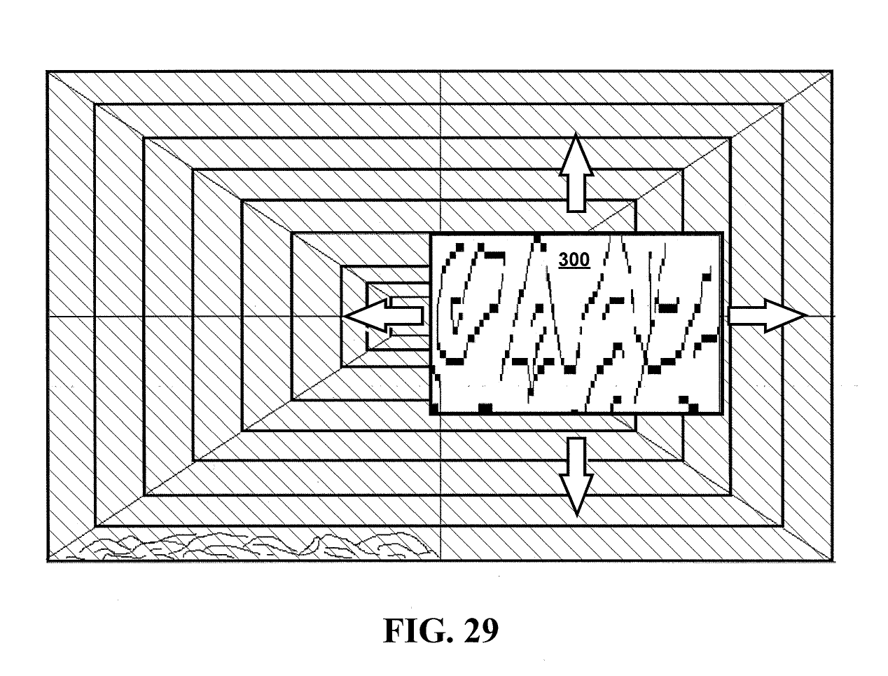

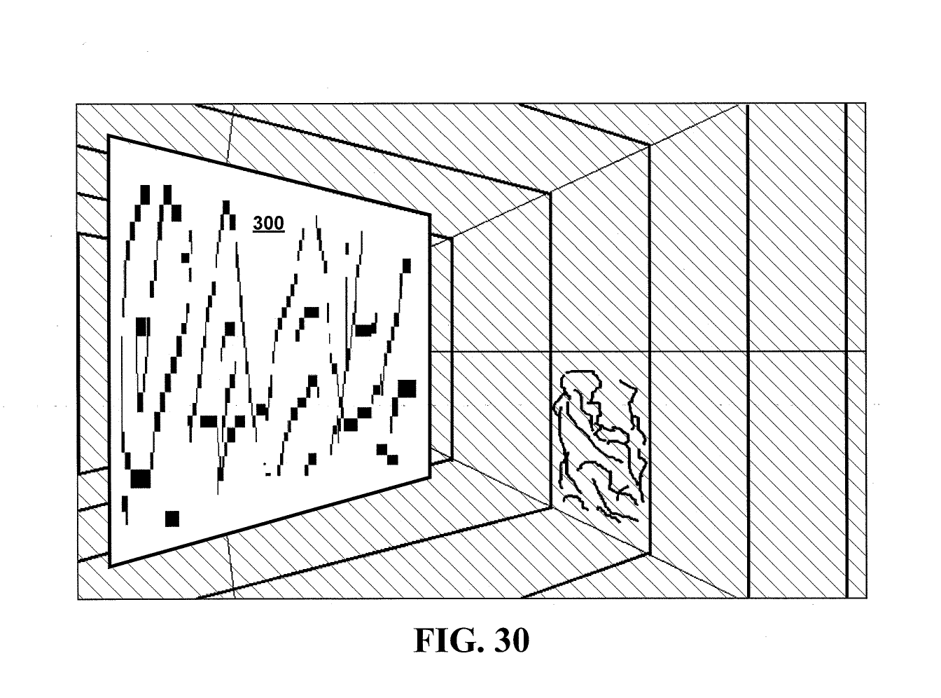

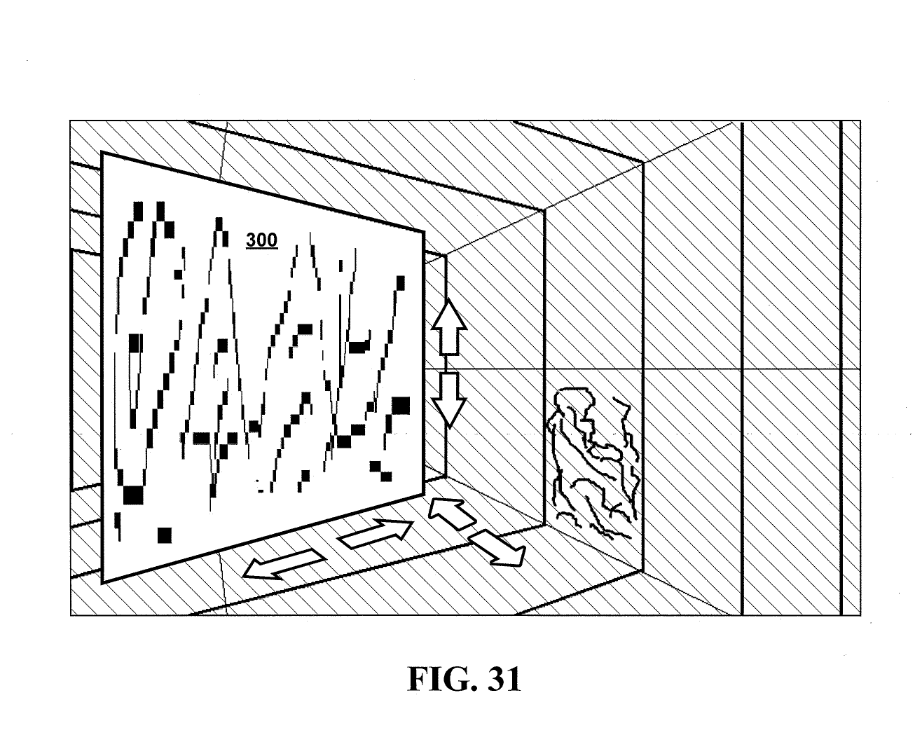

In an embodiment, item display module 50 allows a user to adjust how an opened image file is displayed. In particular, as depicted in FIG. 16, image file 300 may be displayed over a graphical representation of a passageway to give the appearance that image file 300 is displayed at a location in the passageway in front of the user. Item display module 50 allows a user to adjust the apparent distance between the displayed image file and the user. For example, as depicted in FIG. 26 and FIG. 27, image file 300 may be displayed to appear farther from the user, i.e., at a reduced size in FIG. 26, or to appear closer to the user, i.e., at an enlarged size in FIG. 27. In this way, a user may view an image file at varying levels of zoom. FIG. 28 shows image file 300 displayed at a high level of zoom, allowing the user to examine features of image file 300 (e.g., the encircled features) in greater detail. Item display module 50 also allows the user to move a displayed image to the right, or to the left, upwards, or downwards, relative to the user, as depicted in FIG. 29.

In an embodiment, item display module 50 allows a user to turn towards a side wall and view a displayed image file at an oblique angle. For example, FIG. 30 shows image file 300 displayed while the user is turned towards the right sidewall. As depicted in FIG. 31, the user may still adjust the position of the displayed image file while turned towards a sidewall.

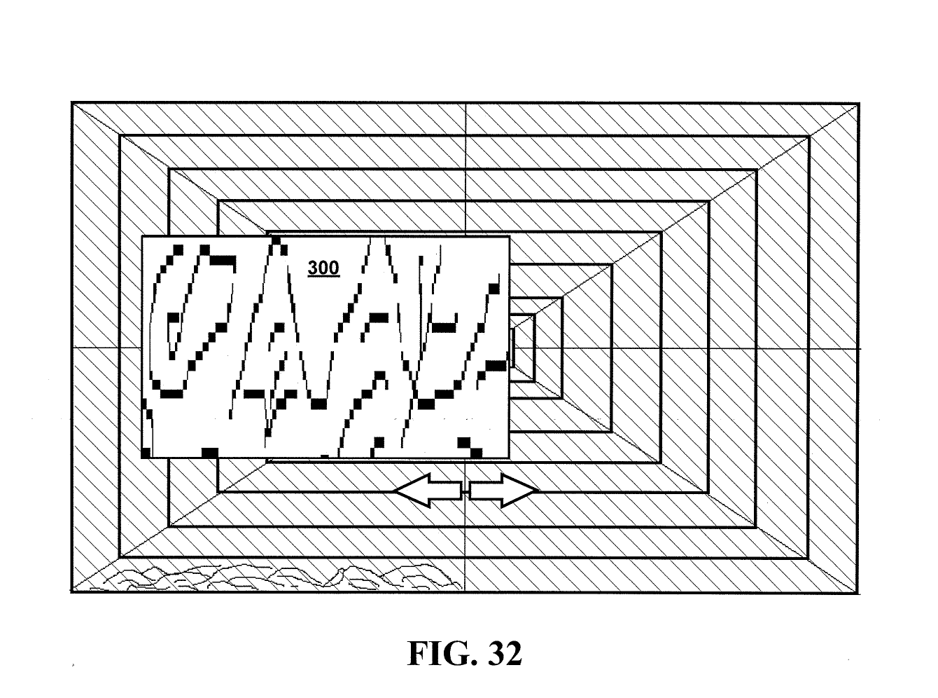

In an embodiment, item display module 50 allows a user to request a displayed image to move automatically and continuously. For example, a displayed image file may be set to move automatically and continuously in alternating directions, as depicted in FIG. 32. Conveniently, in this embodiment, GUI 16 may function as a screen saver application.

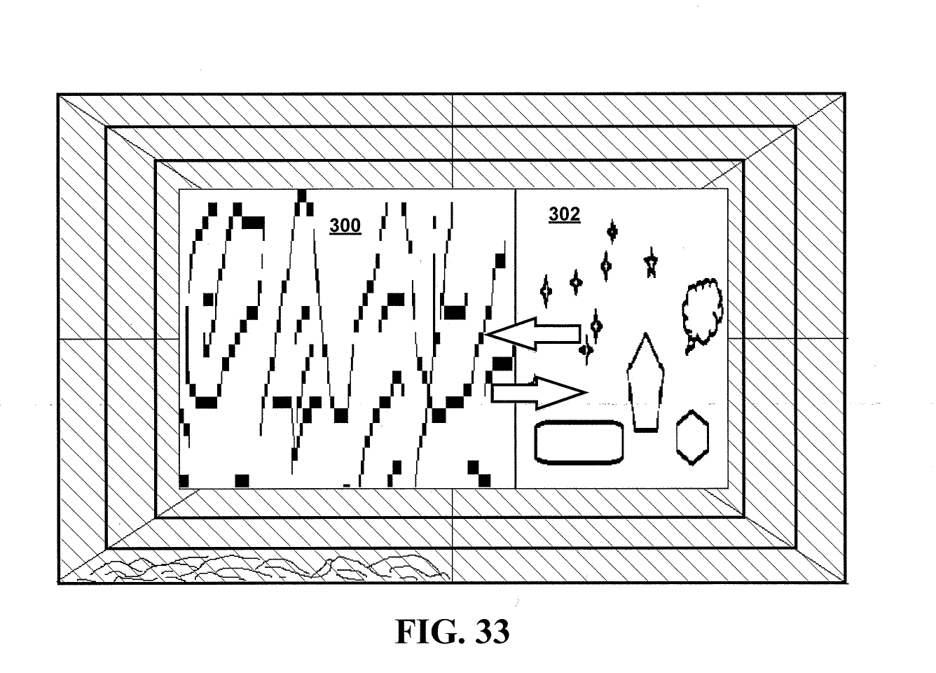

In an embodiment, item display module 50 also allows a user to switch the image file opened for display, namely, to close (deactivate) an image file and open (activate) another image file for display, without requiring the user to select another thumbnail. For example, as depicted in FIG. 33, the opened image file 300 is replaced by image file 302. The replacement image file may be automatically selected from the set of selectable image files. Item display module 50 may change the displayed image file automatically at periodic intervals.

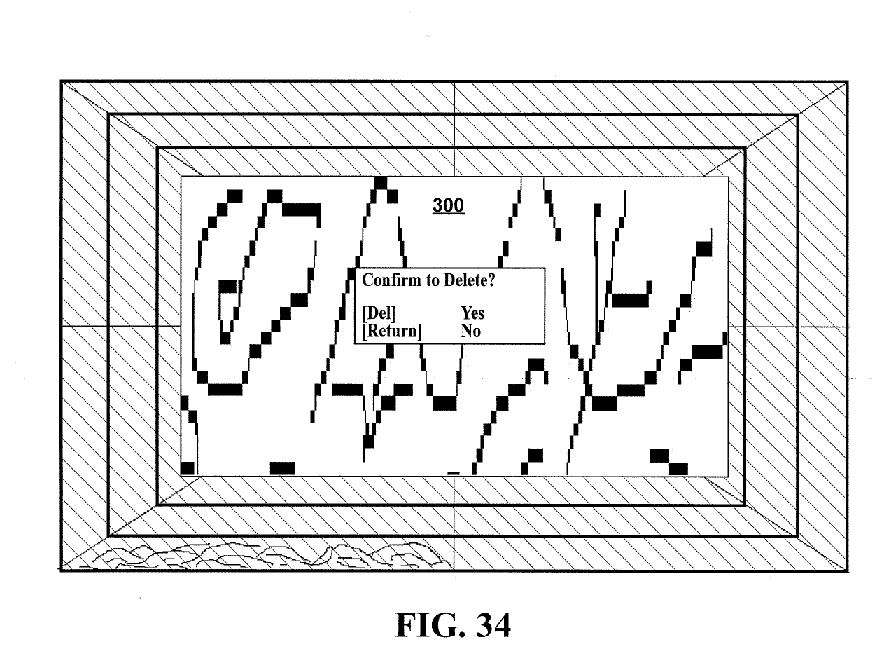

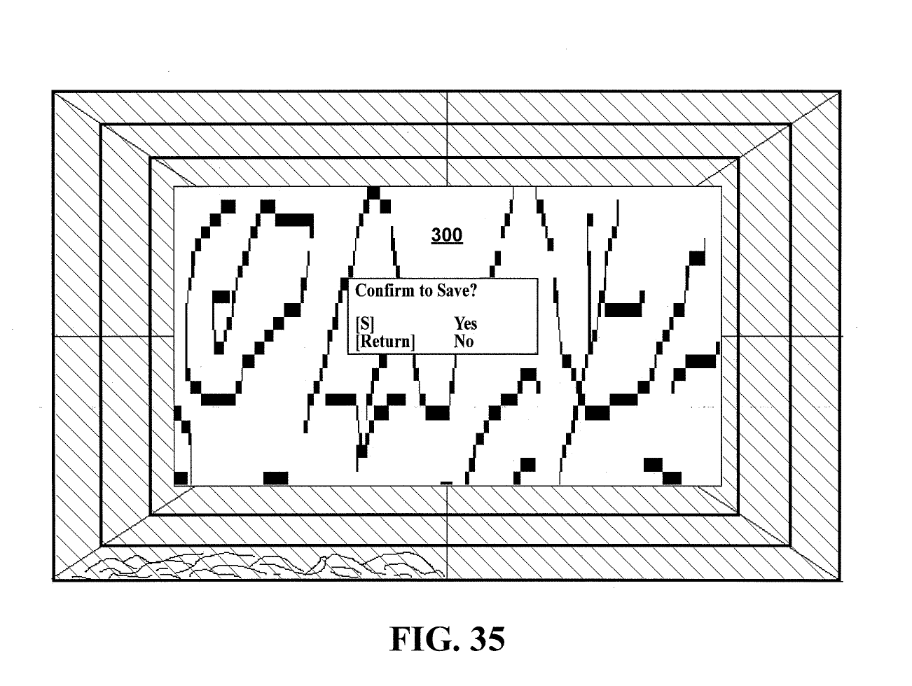

An opened image file may be removed from GUI 16, as shown in FIG. 34. An image file removed in this way may also be deleted from the filesystem in memory 22. An opened image file may be saved to the filesystem in memory 22, as shown in FIG. 35.

In an embodiment, item display module 50 may open a selected image for display by launching a dedicated image viewing application.

In an embodiment, passageway modification module 52 may include a background watchdog process that monitors the filesystem in memory 22 for new image files. When a new image file is added to the filesystem, e.g., in a pre-defined folder, passageway modification module 52 automatically adds that image file to the set of selectable image files presented in GUI 16, and the graphical representation of the passageway is updated. Optionally, the watchdog process may also monitor the filesystem in memory 22 for deletions of selectable image files outside of GUI 16; passageway modification module 52 may automatically remove deleted image files from GUI 16 and update the graphical representation of the passageway accordingly.

In the depicted embodiments, GUI software 40 is adapted to allow users to select from a set of image files. In other embodiments, GUI software 40 may be adapted to allow users to select from other item types. Other item types may include, for example, other types of electronic documents such as movie files, audio files, e-book files, Portable Document Format (PDF) documents, Microsoft Office documents, or the like. Yet other item types may include, for example, executable applications, search results (e.g., transmitted to device 10 by an Internet search engine or provided by a search application executing at device 10), and web pages.

In such embodiments, item identification module 42 may identify selectable items by scanning the filesystem of memory 22 for files of these other types. Once the set of selectable items has been identified, passageway generation module 44 associates each item with a wall panel of a passageway. For each selectable item, passageway generation module 44 identifies or generates an image representative of that item for display on an associated wall panel. The manner in which the appropriate image representative of a selectable item is identified or generated may vary by item type. For example, an image representative of an audio file may be a thumbnail of an album cover. An image representative of an executable application may be an icon representative of that executable application. The image representative of an electronic document like a Microsoft Office document or a PDF document may be a thumbnail of the first page of that document, or an icon representing the type of document.

In some embodiments, passageway generation module 44 may generate a graphical representation of a passageway that presents selectable items of mixed types, thereby allowing a user to view and select from items of mixed types by traversing through a single passageway. For example, passageway generation module 44 may generate a graphical representation of a passageway that simultaneously presents selectable image files, PDF files, and executable applications. When selectable items of mixed types are presented, each of the wall panels forming the graphical representation of the passageway depicts an image representative of its associated selectable item, where the image is chosen or created to be suitable for that item's type.

A user may select a particular one of the selectable items by selecting the image displayed on the wall panel associated with that selectable item. Once an item has been selected, it may be activated, automatically or in response to receiving a request from the user to activate the selected item.

The manner in which a selected item is activated may depend on the item type. When the selected item is a computer file, it may be activated by executing an application to open the selected item, where that application is adapted to open the file type of the selected item. For example, a PDF file may be activated by opening it in a PDF viewer. A movie file or an audio file may be activated by opening it in a suitable player. The appropriate application for opening a particular type of file may be identified by OS software 30. When the selected item is a web page, the web page may be activated by retrieving it using a web browser. When the selected item is an executable application, the selected application may be activated by executing the application at device 10.

In some embodiments, item identification module 42 identifies a set of selectable items from a list retrieved from memory 22 of computing device 10, or received from a computer interconnected with computing device 10 by way of a network.

Although passageways in the depicted embodiments have cross sections that are rectangular in shape, in other embodiments, a passageway may have a cross section of another shape. For example, the shape of a cross section may be square, triangular, or trapezoidal, or the like. The shape of the cross section may also be curved, e.g., circular or oval. Thus, wall panels and the passageway walls formed therefrom need not be flat, but rather may also be curved. The shape of a passageway's cross-section may vary along the length of the passageway. Further, a passageway may be formed from wall panels of disparate shapes and sizes.

Although passageways in the depicted embodiments define a straight path, in other embodiments, passageways may define paths that are curved, or forked. Paths may also be sloped or be in the shape of a staircase.

The term “wall” is used broadly herein to refer to any surface of a passageway including a sidewall, a ceiling, or a floor.

It will be understood that the word “a” or “an” is intended to mean “one or more” or “at least one”, and any singular form is intended to include plurals herein.

It will further be understood that the term “comprise”, including any variation thereof, is intended to be open-ended and means “include, but not limited to,” unless otherwise specifically indicated to the contrary.

When a list of items is given herein with an “or” before the last item, any one of the listed items or any suitable combination of two or more of the listed items may be selected and used.

Of course, the above described embodiments are intended to be illustrative only and in no way limiting. The described embodiments are susceptible to many modifications of form, arrangement of parts, details and order of operation. The invention is intended to encompass all such modification within its scope, as defined by the claims.

What is claimed is:

1. A method of presenting selectable items on an electronic display for selection by a user, comprising:
presenting on the display a plurality of wall panels forming a graphical representation of a passageway appearing to extend away from the user, each one of the wall panels having a panel size commensurate with the apparent distance of said each wall panel to the user, each one of the selectable items being associated with one of the wall panels displaying thereon an image representative of said each selectable item; and
in response to receiving from the user a request for movement along the passageway, updating the graphical representation of the passageway to reflect said movement, such that sizes of visible wall panels in the passageway are adjusted to be commensurate with their respective current apparent distances to the user, thereby allowing the user to traverse the passageway to view and select the image displayed on each one of the wall panels associated with the selectable items.

2. The method of claim 1, further comprising: receiving from the user a request to select the image displayed on a particular one of the wall panels, and in response to the request to select, selecting said particular wall panel as an active panel.

3. The method of claim 2, further comprising: activating the particular selectable item associated with said active panel.

4. The method of claim 3, wherein said activating is in response to receiving from the user a further request to activate the particular selectable item.

5. The method of claim 2, further comprising: updating said graphical representation of the passageway to highlight the active panel.

6. The method of claim 2, further comprising: rotating the active panel to face the user.

7. The method of claim 1, wherein said selectable items are selected from image files, audio files, movie files, executable applications, electronic documents, and web pages.

8. The method of claim 1, wherein said selectable items comprise executable applications, said method further comprising: in response to receiving a request from the user to activate a selected one of the executable applications, executing the selected executable application.

9. The method of claim 1, wherein said selectable items comprise image files, and said method further comprising: in response to receiving a request from the user to activate a selected one of the image files, displaying the selected image file.

10. The method of claim 1, wherein said selectable items comprise electronic documents, said method further comprising: in response to receiving a request from the user to activate a selected one of the electronic documents, executing an application to open the selected electronic document.

11. The method of claim 8, wherein each of the wall panels associated with one of the executable applications displays an icon of said one of the executable applications.

12. The method of claim 1, further comprising: automatically identifying the selectable items by scanning a filesystem for items meeting pre-defined criteria.

13. The method of claim 1, wherein the passageway is three-dimensional and the graphical representation represents a two-dimensional projection of the three-dimensional passageway.

14. The method of claim 1, wherein the wall panels comprise trapezoidal panels that represent two-dimensional projections of rectangular wall panels in the passageway.

15. A computing device comprising:
an electronic display;
a processor;
an input; and
memory storing processor-executable code, said code, when executed by said processor, causing said device to:
present on the display a plurality of wall panels forming a graphical representation of a passageway appearing to extend away from a user of the device, each one of the wall panels having a panel size commensurate with the apparent distance of said each wall panel to the user, each one of a plurality of selectable items being associated with one of the wall panels displaying thereon an image representative of said each selectable item; and
in response to receiving from the user, through the input, a request for movement along the passageway, updating the graphical representation of the passageway to reflect said movement, such that sizes of visible wall panels in the passageway are adjusted to be commensurate with their respective current apparent distances to the user, thereby allowing the user to traverse the passageway to view and select the image displayed on each one of the wall panels associated with the selectable items.

16. The device of claim 15, wherein said selectable items are stored in said memory.

17. The device of claim 15, wherein said device is a desktop computing device, a laptop computing device, a smart phone, a tablet computer, an e-book reader, a set-top-box, a digital video recorder, a gaming console, or a digital television.

18. The device of claim 15, wherein said display is a touchscreen display.

19. The device of claim 15, wherein the passageway is three-dimensional and the graphical representation represents a two-dimensional projection of the three-dimensional passageway.

20. The device of claim 15, wherein the wall panels comprise trapezoidal panels that represent two-dimensional projections of rectangular wall panels in the passageway.
